(19) United States
(12) Patent Application Publication
(10) Pub. No.: US 2013/0099128 A1
(43) Pub. Date: Apr. 25, 2013

(54) RADIATION IMAGE CAPTURING SYSTEM AND RADIATION IMAGE CAPTURING APPARATUS

(71) Applicant: KONICA MINOLTA MEDICAL & GRAPHIC, INC., Tokyo (JP)

(72) Inventors: Atsunori SHIKINO, Atsugi-shi (JP); Satoshi KOMIYA, Tokyo (JP)

(73) Assignee: KONICA MINOLTA MEDICAL & GRAPHIC, INC., Tokyo (JP)

(21) Appl. No.: 13/657,950

(22) Filed: Oct. 23, 2012

(30) Foreign Application Priority Data
Oct. 25, 2011 (JP) 2011-233481
Nov. 25, 2011 (JP) 2011-257223

(51) Int. Cl. G01T 1/17

(52) U.S. Cl. 250/393

(57) ABSTRACT

According to one implementation, a radiation image capturing system includes a radiation image capturing apparatus; and a radiation generating apparatus. The radiation image capturing apparatus includes: a plurality of radiation detecting elements defined by a plurality of scanning lines and a plurality of signal lines; a scanning driving section; a switch section; a reading circuit; and a control section. The control section detects a start of emission of radiation from a radiation source. The control section includes a notifying section which notifies that start of emission of radiation is detected when the start of emission of radiation is detected.

### BACKGROUND

1. Field of the Invention

The present invention relates to a radiation image capturing system and a radiation image capturing apparatus. Specifically, the present invention relates to a radiation image capturing apparatus which can detect start of emission of radiation and a radiation image capturing system including such radiation image capturing apparatus.

2. Description of Related Art

Various radiation image capturing apparatuses are developed such as a direct radiation image capturing apparatus in which charge generated in a detecting element according to the amount of emitted radiation such as X-ray is converted to an electric signal. Another is an indirect radiation image capturing apparatus in which after the emitted radiation is converted to an electromagnetic wave of another wavelength such as an optical light with a scintillator, etc., charge is generated in a photoelectric converting element such as photodiode, etc. according to energy of the converted electromagnetic wave and converted to an electric signal (in other words, image data). In the present invention, the detecting element in the direct radiation image capturing apparatus and the photoelectric converting element in the indirect radiation image capturing apparatus are collectively referred to as a radiation detecting element.

Such type of radiation image capturing apparatus is known as a Flat Panel Detector (FPD) and is conventionally formed together with a supporting stage (or bucky device) (for example, see Japanese Patent Application Laid-Open Publication No. H9-73144). However, lately, a portable radiation image capturing apparatus in which the radiation detecting element, etc. is stored in a housing is developed and is in practical use (for example, see Japanese Patent Application Laid-Open Publication No. 2006-058124, Japanese Patent Application Laid-Open Publication No. H6-342099).

In such radiation image capturing apparatus, for example, as shown in FIG. 5, etc., typically, a plurality of radiation detecting elements 7 which are two dimensional (matrix) are arranged on a detecting section P and a switch section formed with a thin film transistor (TFT) 8 is connected to each radiation detecting element 7.

Then, when radiation image capturing is performed, off voltage is applied to each scanning line 5 from a gate driver 15b (see later described FIG. 5) of a scanning driving section 15, each TFT 8 is set to an off state and the process advances to a charge accumulating state. Then, in this state, radiation is emitted from a radiation source through an object to the radiation image capturing apparatus. With this, charge is generated in each radiation detecting element 7 of the radiation image capturing apparatus by the emission of radiation and the charge is accumulated in each radiation detecting element 7.

Then, after radiation is emitted, on voltage is sequentially applied to each scanning line 5 from the gate driver 15b, charge is read from each radiation detecting element 7 and charge voltage conversion is performed on the charge in a reading circuit 17 to be read as image data D. Image data D is read from each radiation detecting element 7 as described above in the radiation image capturing apparatus.

As a method to realize such radiation image capturing, conventionally there are many examples where capturing is performed by the radiation generating apparatus which includes the radiation source for emitting radiation to the radiation image capturing apparatus and the radiation image capturing apparatus while transmitting and receiving signals between each other.

In this case, when the radiology technician operates the emission switch of the radiation generating apparatus, an emission start signal is transmitted from the radiation generating apparatus to the radiation image capturing apparatus. Then, the radiation image capturing apparatus stops the processing performed until then such as reset processing of each radiation detecting element 7, and applies off voltage to each scanning line 5 from the gate driver 15b of the scanning driving section 15 to set each TFT 8 to an off state.

Then, when an interlock release signal is transmitted from the radiation image capturing apparatus to the radiation generating apparatus, radiation is emitted from the radiation source of the radiation generating apparatus to the radiation image capturing apparatus. As described above, when charge is generated in each radiation detecting element 7 of the radiation image capturing apparatus by the emission of radiation, then the charge is read from each radiation detecting element 7 as the image data D.

When the manufacturer of the radiation image capturing apparatus and the manufacturer of the radiation generating apparatus are the same, the system can be configured so that capturing is performed while signals and information are transmitted and received between the radiation image capturing apparatus and the radiation generating apparatus as described above. However, when the manufacturers are different, the transmission and reception of the signals between the apparatuses cannot always be performed accurately.

Therefore, in such case, the radiation image capturing apparatus needs to be able to detect that the emission of radiation starts without relying on a signal from the radiation generating apparatus. For example, the radiation image capturing apparatus itself can detect start of emission of radiation by a detection method described in Japanese Patent Application Laid-Open Publication No. 2009-219538 or a later described detection method newly derived by the inventors of the present application.

Usually, in such detection methods, the start of emission of radiation is detected by using the point that the data read in the radiation image capturing apparatus, the value such as the current value, etc. becomes large when the radiation is emitted. However, according to the research by the inventors of the present application, it came to be known that the above data or value such as the current value becomes large when shock or pressure is applied to the radiation image capturing apparatus.

Therefore, when shock or pressure is applied to the radiation image capturing apparatus as described above when the radiation image capturing apparatus is performing the detecting processing of start of radiation emission, it may be determined that the emission of radiation starts even though radiation is not emitted to the radiation image capturing apparatus and false detection may occur.

When the start of radiation emission is detected, the radiation image capturing apparatus is usually configured to automatically perform processing such as advancing to a charge accumulating state and reading processing of data D, and then processing such as reading processing of offset data O and transmitting processing of image data D.

When false detection as described above occurs in the above cases, advancing to the charge accumulating state, reading processing of the image D, etc. are performed in the radiation image capturing apparatus. However, when the radiology technician who does not know that the above processing is performed in the radiation image capturing apparatus emits radiation to the radiation image capturing apparatus, the object is not captured or an abnormal image is captured in the read image data D.

Therefore, in such case, usually, capturing needs to be performed again, or radiation needs to be emitted to a body of a patient who is the object. Therefore, there is a possibility of a problem that the amount of radiation to the body of the patient who is the object increases.

In order to avoid such situation, it is desired that the radiology technician, who is about to emit radiation to the radiation image capturing apparatus, is able to know that the radiation image capturing apparatus made a false detection. With such configuration, the radiology technician is able to know the false detection and it is possible to avoid emission of radiation to the radiation image capturing apparatus which cannot obtain normal image data D if radiation is emitted.

### SUMMARY

The present invention has been made in consideration of the above problems, and it is one of main objects to provide a radiation image capturing system and a radiation image capturing apparatus where a radiology technician can accurately avoid emission of radiation to a radiation image capturing apparatus when the radiation image capturing apparatus erroneously detects start of emission of radiation even though radiation is not emitted.

If the radiology technician is able to realize the false detection by the radiation image capturing apparatus, the radiology technician can stop the processing in the radiation image capturing apparatus and the processing can return to the detecting processing of the start of radiation emission. Therefore, the radiation image capturing apparatus can advance to the new capturing action without waiting for processing such as the advancing to the charge accumulating state, reading processing of the image data D, reading processing of the offset data O, etc. to end, and it is possible to immediately end the string of processing of the radiation image capturing.

Therefore, the usability of the radiation image capturing system and the radiation image capturing apparatus improves for the radiology technician. Moreover, the patient who is the object does not have to wait a long time for the next capturing, and therefore the burden of the patient decreases.

Another object of the present invention is to provide a radiation image capturing system and a radiation image capturing apparatus which can immediately return to a state to perform detecting processing of start of radiation emission when the radiation image capturing apparatus falsely detects start of radiation emission.

In order to achieve at least one of the above-described objects, according to an aspect of the present invention, there is provided a radiation image capturing system including:

a radiation image capturing apparatus; and

a radiation generating apparatus which controls a radiation source to emit radiation to the radiation image capturing apparatus, wherein

the radiation image capturing apparatus includes:
a plurality of scanning lines and a plurality of signal lines provided so as to intersect each other;
a plurality of radiation detecting elements which are two dimensional arranged by providing each of the radiation detecting elements in each of small regions defined by the plurality of scanning lines and the plurality of signal lines;
a scanning driving section which applies on voltage or off voltage to each scanning line;
a switch section which is connected to each scanning line and which discharges charge accumulated in the radiation detecting element to the signal line when an on voltage is applied;
a reading circuit which converts the charge discharged from the radiation detecting element to image data to read the image data; and
a control section which drives at least the scanning driving section and the reading circuit to perform reading processing of the image data, wherein
the control section of the radiation image capturing apparatus detects a start of emission of radiation from the radiation source; and
the control section of the radiation image capturing apparatus includes a notifying section which notifies that start of emission of radiation is detected when the start of emission of radiation is detected.

According to another aspect, there is provided a radiation image capturing system including:

a radiation image capturing apparatus;

a radiation generating apparatus which controls a radiation source to emit radiation to the radiation image capturing apparatus; and

a notifying apparatus including a notifying section,

wherein

the radiation image capturing apparatus includes:
a plurality of scanning lines and a plurality of signal lines provided so as to intersect each other;
a plurality of radiation detecting elements which are two dimensional arranged by providing each of the radiation detecting elements in each of small regions defined by the plurality of scanning lines and the plurality of signal lines;
a scanning driving section which applies on voltage or off voltage to each scanning line;
a switch section which is connected to each scanning line and which discharges charge accumulated in the radiation detecting element to the signal line when an on voltage is applied;
a reading circuit which converts the charge discharged from the radiation detecting element to image data to read the image data;
a control section which drives at least the scanning driving section and the reading circuit to perform reading processing of the image data; and
a communication section which transmits the image data to an external apparatus, wherein

the control section of the radiation image capturing apparatus detects a start of emission of radiation from the radiation source and when the start of emission of radiation is detected, the control section transmits to the notifying apparatus a detecting signal showing that the start of emission of radiation is detected; and

when the detecting signal is received from the radiation image capturing apparatus, the notifying apparatus notifies through the notifying section that the radiation image capturing apparatus detected the start of emission of radiation.

According to another aspect of the present invention there is provided a radiation image capturing apparatus including:

a plurality of scanning lines and a plurality of signal lines provided so as to intersect each other;

a plurality of radiation detecting elements which are two dimensional arranged by providing each of the radiation detecting elements in each of small regions defined by the plurality of scanning lines and the plurality of signal lines;

a scanning driving section which applies on voltage or off voltage to each scanning line;

a switch section which is connected to each scanning line and which discharges charge accumulated in the radiation detecting element to the signal line when an on voltage is applied;

a reading circuit which converts the charge discharged from the radiation detecting element to image data to read the image data; and

a control section which drives at least the scanning driving section and the reading circuit to perform reading processing of the image data, wherein

the control section detects a start of emission of radiation from a radiation source; and

the control section includes a notifying section which notifies that start of emission of radiation is detected when the start of emission of radiation is detected.

### BRIEF DESCRIPTION OF THE DRAWINGS

The present invention will become more fully understood from the detailed description given hereinbelow and the appended drawings, and thus are not intended to define the limits of the present invention, and wherein;

FIG. 1 is a perspective view showing an outer appearance of a radiation image capturing apparatus of the present embodiment;

FIG. 2 is a cross sectional view along line X-X shown in FIG. 1;

FIG. 3 is a perspective view showing a state of a connector of a cable connected to a connector of the radiation image capturing apparatus;

FIG. 4 is a planar view showing a configuration of a substrate of the radiation image capturing apparatus;

FIG. 5 is an enlarged view showing a configuration of a radiation detecting element, TFT, etc. formed in a small region on the substrate shown in FIG. 4;

FIG. 6A is a side view describing a substrate on which a flexible circuit substrate, PCB substrate, etc. are attached;

FIG. 6B is an enlarged cross sectional view of a connecting section of a flexible circuit substrate on a rear surface side of the substrate;

FIG. 7 is a block diagram showing an equivalent circuit of the radiation image capturing apparatus;

FIG. 8 is a block diagram showing an equivalent circuit for one pixel composing a detecting section;

FIG. 9 is a timing chart showing timing of on/off of a charging reset switch and TFT in reset processing of each radiation detecting element;

FIG. 10 is a timing chart showing timing of on/off of a charging reset switch, a pulse signal, TFT and reading processing of image data;

FIG. 11 is a diagram showing an example of a configuration of a radiation image capturing system of the present embodiment structured in a capturing room, etc.;

FIG. 12 is a diagram showing an example of a configuration of a radiation image capturing system of the present embodiment structured on a treating car;

FIG. 13 is a diagram describing each charge which leaks from each radiation detecting element through the TFT read as leak data;

FIG. 14 is a timing chart showing timing of on/off of the charging reset switch and the TFT in the reading processing of the leak data;

FIG. 15 is a timing chart showing timing of on/off of the charging reset switch, the pulse signal, and the TFT when the reading processing of the leak data and the reset processing of each radiation detecting element is performed alternately before radiation image capturing;

FIG. 16 is a timing chart describing timing, etc. of applying on voltage to each scanning line in detection method 1;

FIG. 17 is a graph showing an example of progress of time of read leak data;

FIG. 18 is a timing chart showing timing of sequentially applying on voltage to each scanning line when reading processing of image data for detecting start of radiation before radiation image capturing is repeatedly performed in detection method 2;

FIG. 19 is a timing chart showing the on/off timing of the charge reset switch, the pulse signal and the TFT and the on time ΔT in the reading processing of image data for detecting start of emission before radiation image capturing;

FIG. 20 is a timing chart describing timing, etc. of applying the on voltage to each scanning line in detection method 2;

FIG. 21 is a diagram showing a state of defining the detecting section into four regions and assigning a reading IC to each region;

FIG. 22 is a timing chart describing timing of applying on voltage to each scanning line in the reset processing of a short cycle;

FIG. 23 is a sequence diagram showing an example of a sequence such as communication, transmission of data, etc. between a portable terminal, a console and the radiation image capturing apparatus; and

FIG. 24 is a diagram showing a state of the radiology technician holding the portable terminal in the radiation image capturing system shown in FIG. 12.

### DETAILED DESCRIPTION OF PREFERRED EMBODIMENTS

An embodiment of the radiation image capturing system and the radiation image capturing apparatus of the present invention is described with reference to the drawings.

Below, as the radiation image capturing apparatus, the present embodiment describes an indirect radiation image capturing apparatus including a scintillator, etc. and which converts emitted radiation to a electromagnetic wave with another wavelength such as visible light to obtain an electric signal. However, the present invention can be applied to a direct radiation image capturing apparatus in which radiation is directly detected with a radiation detecting element without a scintillator, etc.

### [Radiation Image Capturing Apparatus]

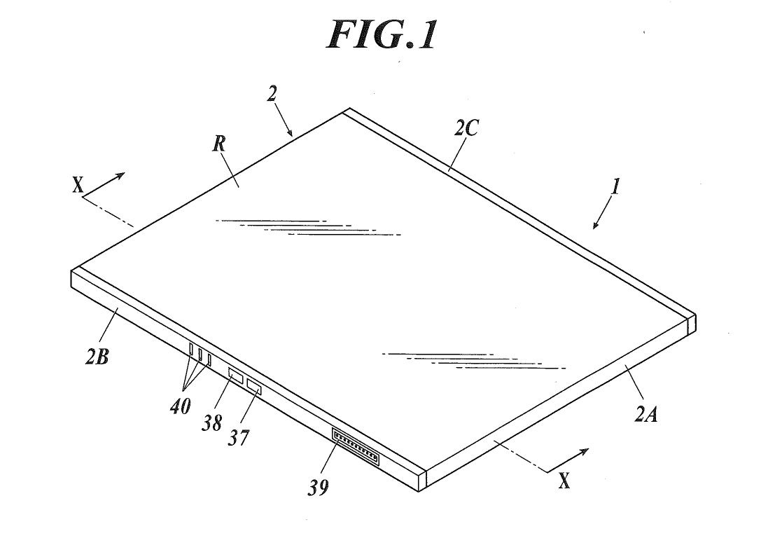

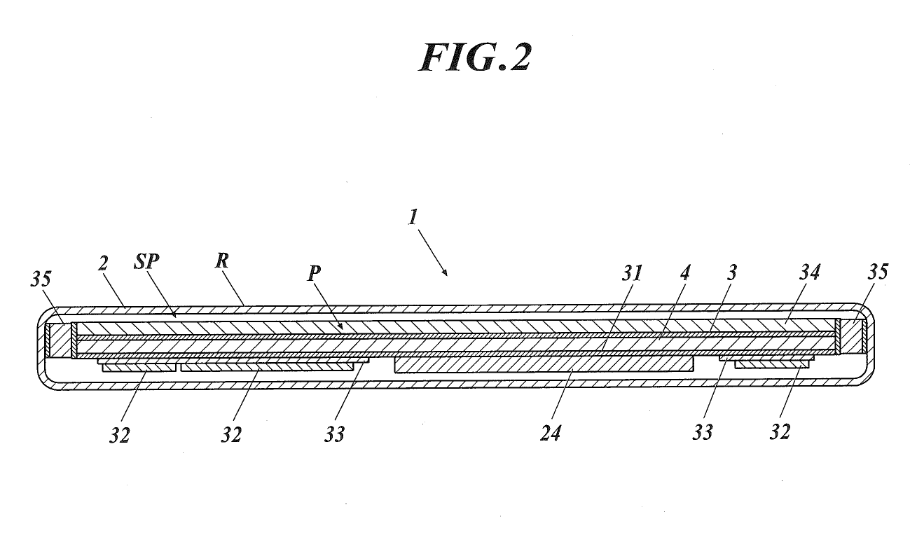

The configuration, etc. of a radiation image capturing apparatus of the present embodiment is described. FIG. 1 is a perspective view showing an outer appearance of the radiation image capturing of the present embodiment, and FIG. 2 is a cross sectional view along line X-X shown in FIG. 1. As shown in FIG. 1 and FIG. 2, the radiation image capturing apparatus 1 includes a sensor panel SP composed of a scintillator 3, substrate 4, and the like in a case 2.

According to the present embodiment, in the case 2, a case main body section 2A in a hollow square tube shape including a radiation entrance surface R is formed with a material such as a carbon plate, plastic, etc. which passes radiation and openings of both sides of the case main body section 2A are closed with a cover member 2B and 2C to form the case 2. The cover member 2B of one side of the case 2 is provided with a power source switch 37, a switching switch 38, a connector 39, an indicator 40 composed of LED, etc. which displays a state of a battery, a state of operation of the radiation image capturing apparatus 1, etc.

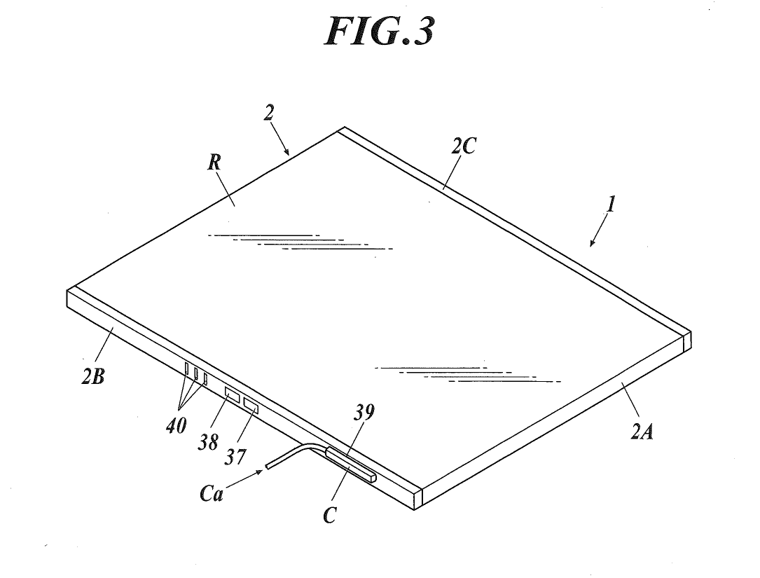

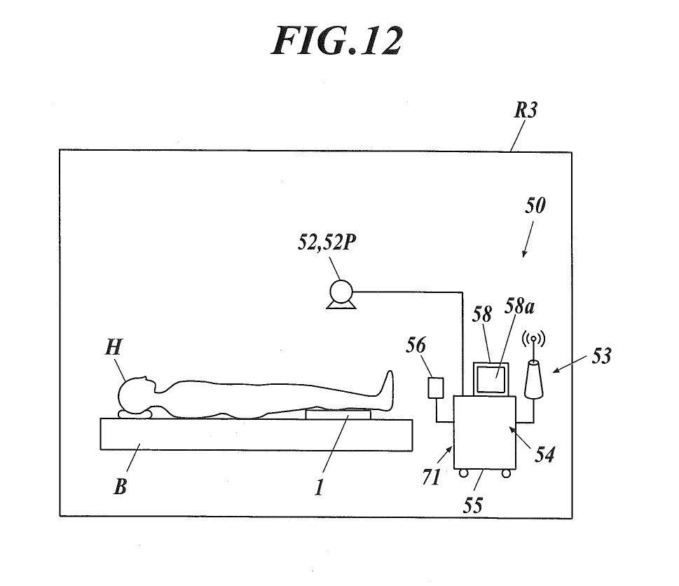

For example, as shown in FIG. 3, according to the present embodiment, by connecting a connector C provided on a tip of the cable Ca to the connector 39, the connector 39 functions as a wired communicating section when signals, etc. are transmitted and received and image data D, etc. is transmitted through the cable Ca between an apparatus such as an external console 58 (see FIG. 11 and FIG. 12 described later).

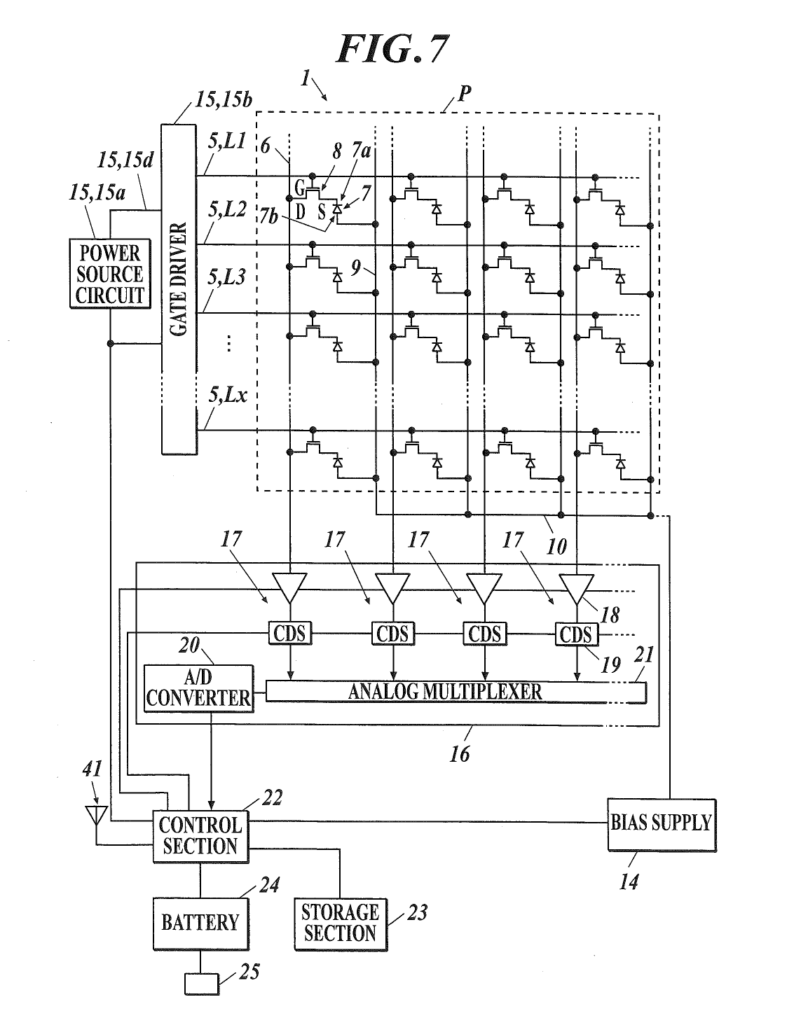

Although illustration is omitted, an antenna apparatus 41 (see FIG. 7 described later) is provided, for example, embedded in the cover member 2C on the opposite side of the case 2. According to the present embodiment, the antenna apparatus 41 functions as the communication section which transmits and receives signals, etc. wirelessly between the radiation image capturing apparatus 1 and the console 58.

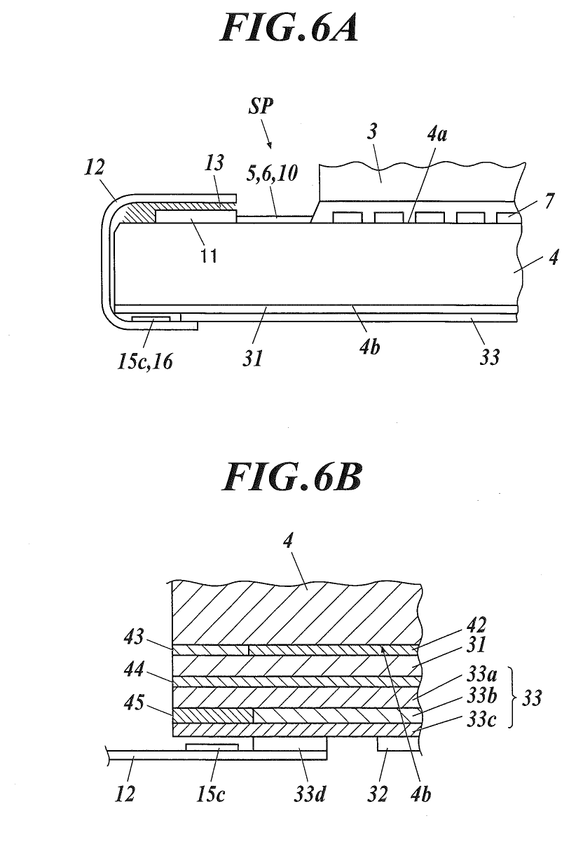

As shown in FIG. 2, a base 31 is provided on a lower side of the substrate 4 inside the case 2 with a shielding plate such as lead, etc. to shield radiation in between (illustration omitted in FIG. 2, see later described shielding plate 42 in FIG. 6B). A PCB substrate 33 provided with electronic components 32, etc., battery 24, etc. and the like are attached to the base 31. A glass substrate 34 to protect the above is provided on the radiation entrance surface R of the scintillator 3 and substrate 4. In the present embodiment, cushioning material 35 is provided between a sensor panel SP and a side surface of the case 2.

The scintillator 3 is provided in a position opposite a later described detecting section P of the substrate 4. According to the present embodiment, for example, the scintillator 3 to be used includes a fluorescent material as a main component and when radiation is received, the scintillator converts the radiation to an electromagnetic wave with a wavelength of 300 to 800 nm, in other words, an electromagnetic wave mainly of visible light and the electromagnetic wave is output.

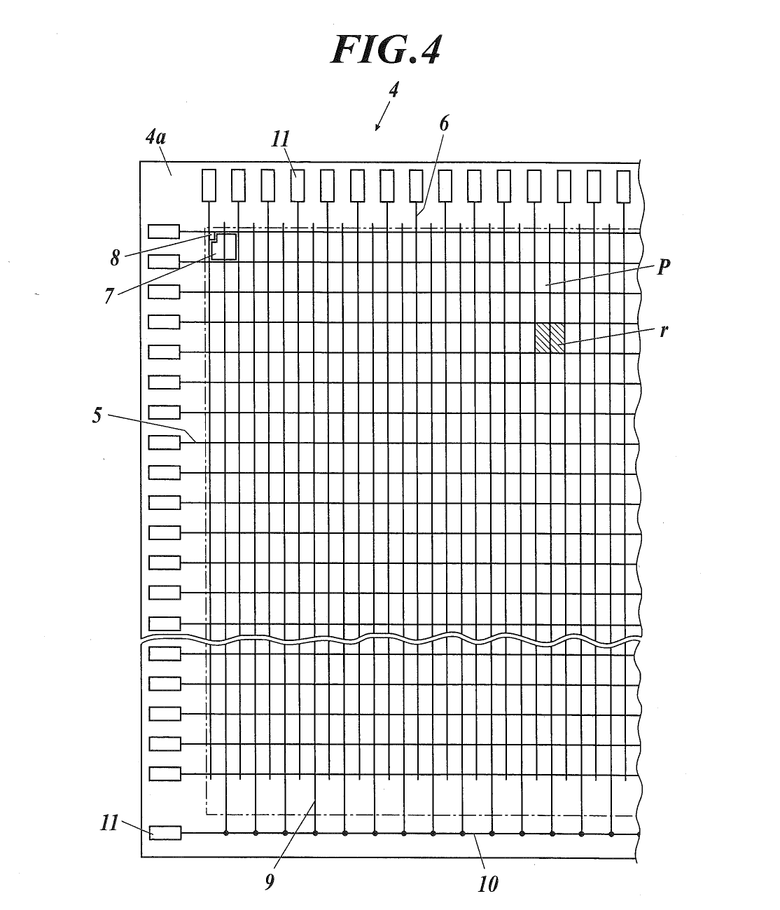

According to the present embodiment, the substrate 4 is composed of a glass substrate, and as shown in FIG. 4, a plurality of scanning lines 5 and a plurality of signal lines 6 are provided to cross each other on a surface 4a on the opposite side of the scintillator 3 of the substrate 4. The radiation detecting elements 7 are each provided in each small region r defined by the plurality of scanning lines 5 and the plurality of signal lines 6 on the face 4a of the substrate 4.

As described above, a region defined into small regions r by scanning lines 5 and signal lines 6 is provided with a plurality of radiation detecting elements 7 provided in two dimensions and the entire region of the small regions r, in other words, the region shown with alternate long and short dash line in FIG. 4 is to be the detecting section P.

When the radiation enters from the radiation entrance surface R of the case 2 of the radiation image capturing apparatus 1 and the electromagnetic wave such as visible light, etc. converted from the radiation in the scintillator 3 is emitted, electron-hole pairs are generated in the radiation detecting element 7. With this, the emitted radiation (according to the present embodiment, an electromagnetic wave converted from radiation with the scintillator 3) is converted to charge in the radiation detecting element 7.

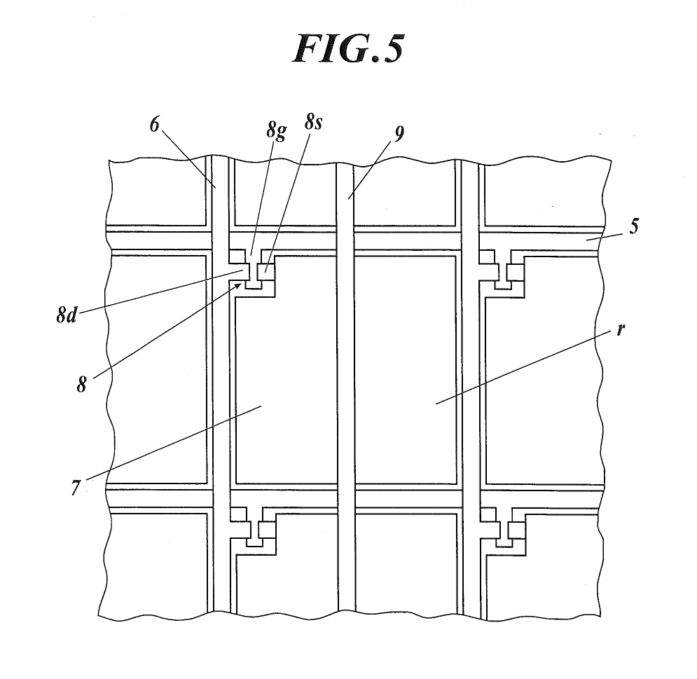

According to the present embodiment, a photodiode is used as the radiation detecting element 7, however, other than the above, for example, a phototransistor, etc. can be used. As shown in FIG. 5 which is the enlarged diagram of FIG. 4, the radiation detecting elements 7 are connected to a source electrode 8s of the TFT 8 which is a switch section. The drain electrode 8d of the TFT 8 is connected to the signal line 6.

When the on voltage is applied to the gate electrode 8g through the scanning line 5 from a later described scanning driving section 15, the TFT 8 becomes the on state, and charge accumulated in the radiation detecting element 7 is discharged to the signal line 6 through the source electrode 8s and drain electrode 8d. When the off voltage is applied to the gate electrode 8g through the connected scanning line 5, the TFT 8 becomes the off state, and discharge of charge from the radiation detecting element 7 to the signal line 6 stops to accumulate charge in the radiation detecting element 7.

According to the present embodiment, as shown in FIG. 5, a plurality of radiation detecting elements 7 provided in columns are connected to one bias line 9 and as shown in FIG. 4, each bias line 9 is provided parallel to each signal line 6. Each bias line 9 is band by a connecting line 10 in a position outside the detecting section P of the substrate 4.

As shown in FIG. 4, according to the present embodiment, each scanning line 5, each signal line 6, and the connecting line 10 of the bias line 9 are connected to an input/output terminal (pad) 11 provided near the edge of the substrate 4.

As shown in FIG. 6A, a flexible circuit substrate 12 (also called a Chip On Film, etc.) in which a chip such as a later described reading IC 16 or a gate IC 15c composing a gate driver 15b of the scanning driving section 15 is embedded on a film is connected to each input/output terminal 11 through an anisotropic conductive material 13 such as an anisotropic conductive film or anisotropic conductive paste.

Then, the flexible circuit substrate 12 is pulled to a rear surface 4b side of the substrate 4 and connected to the above described PCB substrate 33 on the rear surface 4b side. With this, the sensor panel SP of the radiation image capturing apparatus 1 is formed. In FIG. 6A, the illustration of the electronic components 32, etc. is omitted.

FIG. 6B shows an enlarged cross sectional view of a connecting section of a flexible circuit substrate 12 on the rear surface 4b side of the substrate 4 of the sensor panel SP. As shown in FIG. 6B, depending on the radiation image capturing apparatus, the shielding plate 42 such as lead, etc. between the substrate 4 and the base 31 is not provided extending to the edge of the substrate 4, and in the edge portion of the substrate 4, there may be a space between the substrate 4 and the base 31 or an adhesive 43 may be filled in the portion.

In such configuration, when radiation enters the radiation entrance surface R (see FIG. 1, FIG. 2, etc.) of the radiation image capturing apparatus 1, the radiation is not shielded by the shielding plate 42, the radiation transmits through the substrate 4, base 31, etc. and the radiation is emitted to the chip such as the reading IC 16, gate IC 15c, etc., embedded in the flexible circuit substrate 12.

According to the research by the inventors of the present application, when the radiation image capturing is repeated and emission of radiation on the gate IC 15c is repeated, the gate IC 15c deteriorates with time, and it is known that the image data D read from the radiation detecting elements 7 connected to each scanning line 5 connected to the deteriorated gate IC 15c is in a state superposed with a certain offset value.

Even if the offset value is superposed on the image data D read from the radiation detecting element 7, as described later, in the radiation image capturing apparatus 1, the offset data O is read for each radiation detecting element 7 and the same offset value is superposed on the offset data O.

Therefore, as described later, if the offset data O is subtracted from the image data D for each radiation detecting element 7 and the true image data D* is calculated, the offset value of the image data D and the offset value of the offset data O are balanced, and the offset value is not superposed on the true image data D*. Therefore, when the radiation image I is generated based on the image data D, etc., it is not a large problem even if the offset value is superposed on the data due to deterioration of the gate IC 15c.

However, as described later, the present embodiment is configured so that the radiation image capturing apparatus 1 itself detects the start of the radiation emission. The present embodiment is configured so that the reading processing of leak data dleak (see later described detection method 1), etc. is performed before radiation image capturing. The present embodiment is configured to detect that the emission of radiation starts when the read leak data dleak, etc. exceeds the threshold value dleak_th, etc.

As described above, if the offset value due to deterioration of the gate IC 15c is superposed to the read leak data dleak or the emission start detecting image data d, the read leak data dleak, etc. with fluctuation easily exceeds the threshold value dleak_th and there is a problem that false detection of start of emission of radiation easily occurs even if the radiation is not emitted to the radiation image capturing apparatus 1.

According to the present embodiment, as shown in FIG. 6B, a PCB substrate 33 is attached to the rear surface of the base 31 of the sensor panel SP with a cushioning material 44 in between and a shielding plate 45 such as lead, etc. is provided in the PCB substrate 33 provided with electronic components 32, etc.

According to the present embodiment, in the PCB substrate 33, an inner layer 33b on which a circuit, etc. is provided is formed on the rigid substrate 33a (here, “on” means lower portion in FIG. 6B), a resist layer 33c is formed on the inner layer 33b, and electronic components 32, input/output terminal 33d, line patterns which are not shown, etc., are provided on the resist layer 33c. According to the present embodiment, a flexible circuit substrate 12 is connected to each input/output terminal 33d on the PCB substrate 33 side similar to when connecting to each input/output terminal 11 (see FIG. 6A) formed on the substrate 4.

The shielding plate 45 is provided in a position of the PCB substrate 33 where it is possible to shield the radiation so as not to reach at least the gate IC 15c on the flexible circuit substrate 12. In the present embodiment, as shown in FIG. 6B, the shielding plate 45 is provided on the same layer as the inner layer 33b which is between the rigid substrate 33a and the resist layer 33c of the PCB substrate 33.

As described above, by providing a shielding plate 45 on the PCB substrate 33, the gate IC 15c deteriorating over time due to radiation repeatedly emitted on the gate IC 15c can be accurately prevented. Therefore, when a later described detection method 1 and detection method 2 are employed and the radiation image capturing apparatus 1 itself detects the start of radiation emission, false detection of the start of radiation emission easily occurring due to deterioration of the gate IC 15c over time can be accurately prevented.

As described above, by providing a shielding plate 45 to the PCB substrate 33, for example as described above, even if the shielding plate 42 such as lead, etc. is not provided extended to the edge of the substrate 4 of the sensor panel SP, and the emitted radiation reaches the gate IC 15c on the flexible circuit substrate 12, the gate IC 15c can be accurately shielded from radiation by simply attaching the PCB substrate 33 provided with the shielding plate 45 on the substrate 4, the base 31, etc., and shielding of the gate IC 15c can be performed easily and accurately.

It is possible to provide the shielding plate 45 in a position of the PCB substrate 33 which shields the radiation so that the radiation does not reach the reading IC 16 (see FIG. 6A, etc.) on the flexible circuit substrate 12. According to such configuration, similar to the gate IC 15c, deterioration of the reading IC 16 over time due to radiation can be prevented.

FIG. 6B shows the shielding plate 45 provided on a same layer as the inner layer 33b between the rigid substrate 33a and the resist layer 33c of the PCB substrate 33. Other than the above, for example, the shielding plate 45 can be provided on the same layer as the rigid substrate 33a and the resist layer 33c, on the surface of the rigid substrate 33a on the base 31 side, on the surface of the resist layer 33c on the side where the electronic components 32 are provided or embedded in the rigid substrate 33a or the resist layer 33c.

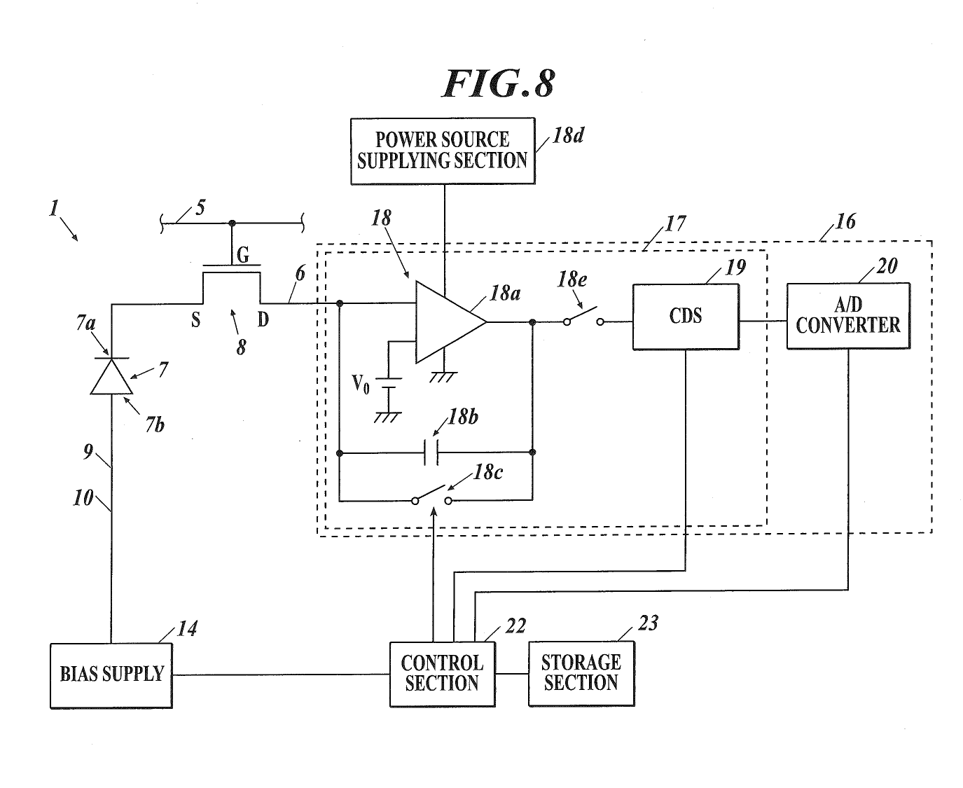

Here, the circuit configuration of the radiation image capturing apparatus 1 is described. FIG. 7 is a block diagram showing an equivalent circuit of the radiation image capturing apparatus 1 of the present embodiment and FIG. 8 is a block diagram showing an equivalent circuit for one pixel composing the detecting section P.

As described above, in each radiation detecting element 7 of the detecting section P of the substrate 4, the bias lines 9 are connected to the second electrode 7b and the bias lines 9 are banded by the connecting line 10 to be connected to the bias supply 14. The bias supply 14 applies a reverse bias voltage (in other words, the voltage no more than the voltage applied to the first electrode 7a side of the radiation detecting element) to the second electrode 7b of each radiation detecting element 7 through the bias line 9 and the connecting line 10.

The scanning driving section 15 includes a power source circuit 15a which supplies an on voltage and an off voltage to a gate driver 15b through line 15d, and the gate driver 15b which switches the voltage applied to each line L1 to Lx of the scanning line 5 between the on voltage and the off voltage to switch between the on state and the off state of the TFT 8. According to the present embodiment, the gate driver 15b is configured with a plurality of the previously described gate IC 15c arranged aligned (see FIG. 6A and FIG. 6B).

As shown in FIG. 7 and FIG. 8, each signal line 6 is connected to each reading circuit 17 in the reading IC 16. The reading circuit 17 includes an amplifying circuit 18, a correlated double sampling circuit 19, etc. An analog multiplexer 21 and an A/D converter 20 are also provided in the reading IC 16. The correlated double sampling circuit 19 is referred to as CDS in FIG. 7 and FIG. 8. The analog multiplexer 21 is omitted in FIG. 8.

According to the present embodiment, the amplifying circuit 18 includes a charge amplifier circuit including an operational amplifier 18a, a condenser 18b and a charge reset switch 18c which are each connected in parallel with the operational amplifier 18a and a power source supplying section 18d which supplies electric power to the operational amplifier 18a, etc. A signal line 6 is connected to the inverting input terminal of the input side of the operational amplifier 18a of the amplifying circuit 18 and a reference potential V0 is applied to the non-inverting input terminal of the input side of the amplifying circuit 18.

The charge reset switch 18c of the amplifying circuit 18 is connected to the control section 22, and the control section 22 controls on/off. A switch 18e is provided to open and close interlocking with the charge reset switch 18c between the operational amplifier 18a and the correlated double sampling amplifying circuit 19, and the switch 18e performs on/off operation interlocking with the on/off operation of the charge reset switch 18c.

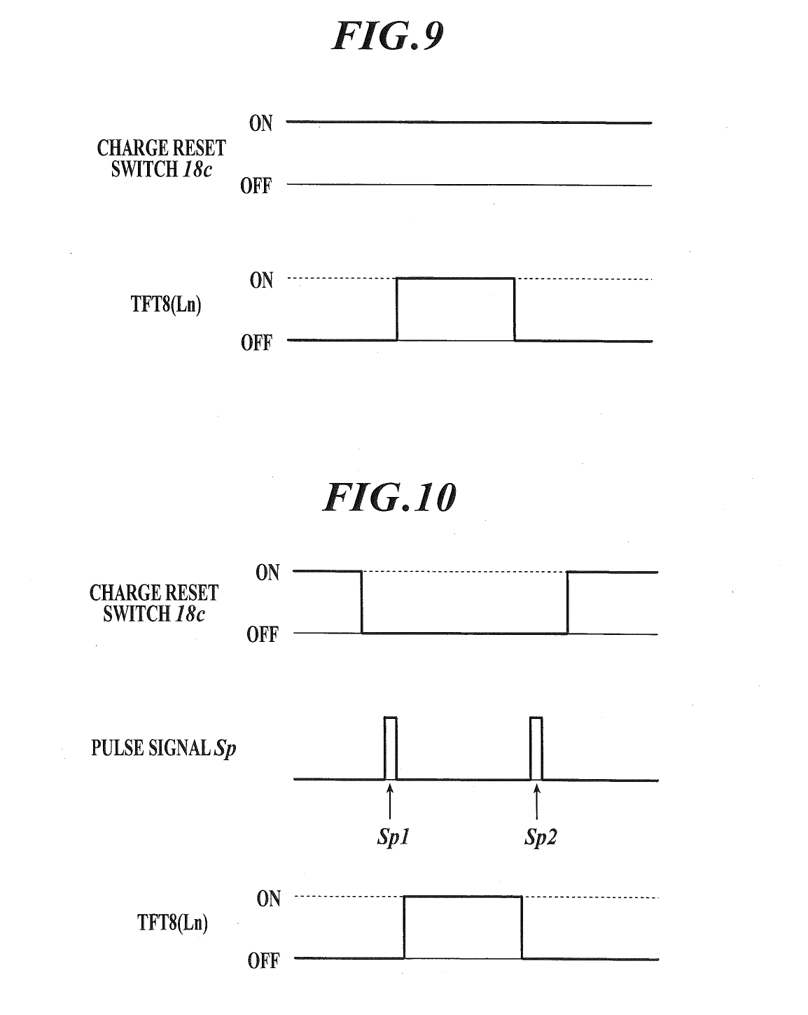

In the radiation image capturing apparatus 1, when the reset processing of each radiation detecting element 7 to remove charge remaining in each radiation detecting element 7 is performed, each TFT 8 is set to an on state in a state where the charge reset switch 18c is set to an on state (and the switch 18e is set to an off state) as shown in FIG. 9.

Then, charge is discharged from each radiation detecting element 7 to the signal line 6 through each TFT 8 set to an on state. The charge passes through the charge reset switch 18c of the amplifying circuit 18 and passes the operational amplifier 18a from the output terminal side of the operational amplifier 18a. The charge flows out from the non-inverting input terminal and is grounded. The charge flows out to a power source supplying section 18d. In this way, the reset processing of each radiation detecting element 7 is performed.

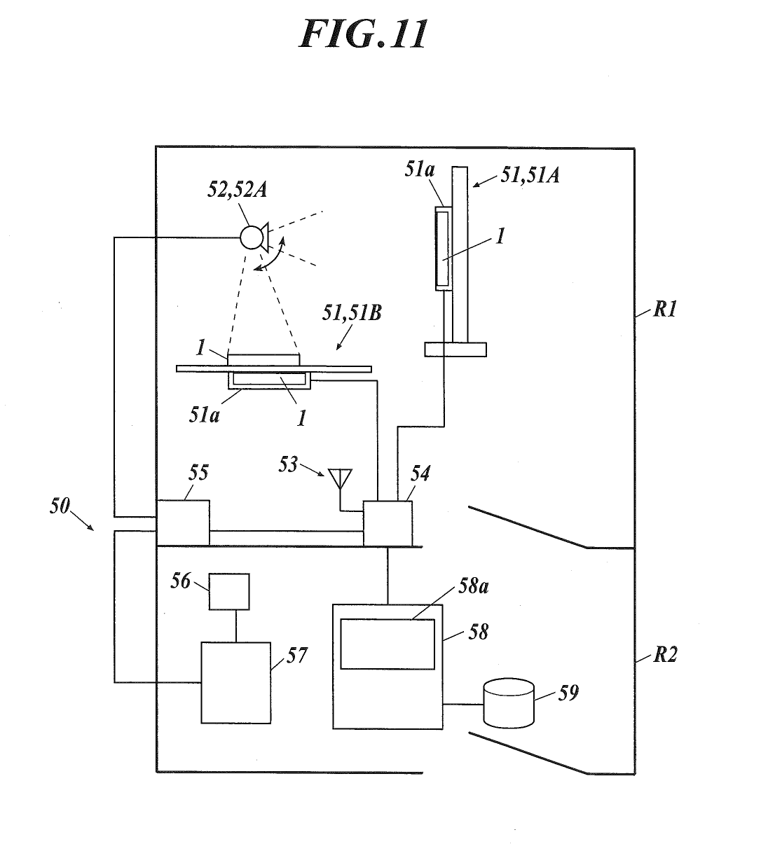

In the reading processing of the image data D from each radiation detecting element 7, as shown in FIG. 10, when the charge is discharged from each radiation detecting element 7 to the signal line 6 through each TFT 8 in an on state, in a state where the charge reset switch 18c of the amplifying circuit 18 is an off state (and the switch 18e is in an on state) the charge is accumulated in the condenser 18b of the amplifying circuit 18.

In the amplifying circuit 18, a voltage value depending on the charge amount accumulated in the condenser 18b is output from the output side of the operational amplifier 18a, and the amplifying circuit 18 performs charge to voltage conversion on the charge flown out from each radiation detecting element 7.

When the pulse signal Sp1 (see FIG. 10) is transmitted from the control section 22 before flowing the charge from each radiation detecting element 7, the correlated double sampling amplifying circuit 19 provided on the output side of the amplifying circuit 18 holds the voltage value Vin output from the amplifying circuit 18 at this point, and when the pulse signal Sp2 is transmitted from the control section 22 after the charge which flows out from the radiation detecting elements 7 as described above is accumulated in the condenser 18b of the amplifying circuit 18, the correlated double sampling circuit 19 holds the voltage value Vfi output from the amplifying circuit 18 at this point.

Then, the correlated double sampling amplifying circuit 19 calculates the difference Vfi−Vin of the voltage values and the calculated difference Vfi−Vin is output to the downstream side as the image data D of the analog value. Then, each of the image data D of each radiation detecting element 7 output from the correlated double sampling circuit 19 is sequentially transmitted to the A/D converter 20 through the analog multiplexer 21, sequentially converted to image data D with a digital value in the A/D converter 20, and output to the storage section 23 to be sequentially stored.

The control section 22 includes a computer including a CPU (Central Processing Unit), a ROM (Read Only Memory), a RAM (Random Access Memory), an input/output interface, etc. connected to a bus, a FPGA (Field Programmable Gate Array), and the like which are not shown. The control section 22 can include a dedicated control circuit.

The control section 22 controls the operation of each member of the radiation image capturing apparatus 1. As shown in FIG. 7, etc., the control section 22 is connected to the storage section 23 including a SRAM (static RAM), SDRAM (synchronous DRAM), etc.

In the present embodiment, the above described antenna apparatus 41 is connected to the control section 22. A battery 24 which supplies electric power to each member such as the detecting section P, the scanning driving section 15, the reading circuit 17, the storage section 23, bias supply 14, etc. is connected to the control section 22. A connecting terminal 25 for supplying electrical power to the battery 24 from a charging device not shown to charge the battery 24 is attached to the battery 24.

As described above, the control section 22 controls operation of each functioning section of the radiation image capturing apparatus 1, such as controlling the scanning driving section 15, the reading circuit 17, etc. to perform reading processing of image data D, reset processing of each radiation detecting element 7, etc.

According to the present embodiment, the radiation image capturing apparatus 1 detects start of emission of radiation with the apparatus itself. The control configuration is described after describing the configuration of the radiation image capturing system of the present embodiment.

### [Radiation Image Capturing System]

Next, a radiation image capturing system 50 of the present embodiment is described. FIG. 11 is a diagram showing an example of a configuration of the radiation image capturing system 50 of the present embodiment. FIG. 11 shows an example of building the radiation image capturing system 50 in a capturing room R1, etc.

A bucky apparatus 51 is provided in the capturing room R1 and the bucky apparatus 51 can be used by mounting the above described radiation image capturing apparatus 1 in the cassette holding section 51a (cassette holder). FIG. 11 shows an example of providing a bucky apparatus 51A for capturing in a standing position and a bucky apparatus 51B for capturing in a lying position as the bucky apparatus 51, however, only either one of the bucky apparatus 51 may be provided.

As shown in FIG. 11, at least one radiation source 52A which emits radiation to the radiation image capturing apparatus 1 mounted on the bucky apparatus 51 through an object is provided in the capturing room R1. According to the present embodiment, the radiation can be emitted to either of the bucky apparatus 51A for capturing in a standing position or the bucky apparatus 51B for capturing in a lying position by moving the position of the radiation source 52A or changing the emitting direction of the radiation.

A repeater (also called a base station, etc.) 54 for repeating communication, etc. between the apparatuses inside the capturing room R1 and the apparatuses outside the capturing room R1 is provided in the capturing room R1. In the present embodiment, a wireless antenna (also called an access point) 53 is provided in the repeater 54 so that the radiation image capturing apparatus 1 can perform transmitting and receiving of image data D, signals, etc. with a wireless method.

The repeater 54 is connected to the radiation generating apparatus 55 and the console 58. A converter (not shown) which converts the signal, etc. for LAN (local Area Network) communication transmitted from the radiation image capturing apparatus 1, console 58, etc. to the radiation generating apparatus 55 to the signal, etc. for the radiation generating apparatus 55 and vice versa is internally included in the repeater 54.

In the present embodiment, an operation table 57 of the radiation generating apparatus 55 is provided in the front room R2 (also called the operation room, etc.). An exposure switch 56 is provided in the operation table 57. When the operator such as the radiology technician operates the exposure switch 56, the radiation generating apparatus 55 emits radiation from the radiation source 52.

The radiation generating apparatus 55 performs various control such as moving the radiation source 52 to a predetermined position, adjusting the direction of emission of radiation of the radiation source 52, adjusting a diaphragm, collimator, or the like which is not shown so that the radiation is emitted within a predetermined region of the radiation image capturing apparatus 1, and adjusting the radiation source 52 so that a suitable amount of radiation is emitted.

As shown in FIG. 11, in the present embodiment, a console 58 including a computer, etc. is provided in the front room R2. The console 58 can be provided in the capturing room R1, the outside of the front room R2, in a different room, etc., and can be provided in a suitable position.

The console 58 is provided with a display section 58a including a CRT (Cathode Ray Tube), a LCD (Liquid Crystal Display), etc., an input section such as a mouse, a keyboard, etc. not shown, a notifying section such as a speaker, etc. and the like. A storage section 59 including a HDD (Hard Disk Drive) etc. is connected to or mounted in the console 58.

As shown in FIG. 12, the radiation image capturing apparatus 1 can be used independently without mounting in a bucky apparatus 51. For example, when a patient H cannot get up from a bed B of a hospital room R3 and cannot go to the capturing room R1, as shown in FIG. 12, the radiation image capturing apparatus 1 can be brought into the hospital room R3, and can be inserted between the bed B and the body of the patient or placed against the body of the patient.

When the radiation image capturing apparatus 1 is used in the hospital room R3, etc., instead of the radiation generating apparatus 55 set in the above described capturing room R1, as shown in FIG. 12, a portable radiation generating apparatus 55 is brought into the hospital room R3 by mounting on, for example a treating car 71.

In this case, the radiation 52P of the portable radiation generating apparatus 55 emits radiation in any direction. The radiation 52P can be emitted from a suitable distance or direction to the radiation image capturing apparatus 1 inserted between the bed B and the body of the patient or placed against the body of the patient.

In this case, the repeater 54 provided with the wireless antenna 53 is mounted inside the radiation generating apparatus 55, and similar to the above, the repeater 54 relays the communication between the radiation generating apparatus 55 and the consoler 58, the communication between the radiation image capturing apparatus 1 and the console 58, the transmission of the image data D and the like.

As shown in FIG. 11, the radiation image capturing apparatus 1 can be used by inserting between the body of the patient lying on the bucky apparatus 51B for capturing in a lying position in the capturing room R1 and the bucky apparatus 51B for capturing in a lying position or by placing against the body of the patient on the bucky apparatus 51B for capturing in a lying position. In this case, the portable radiation 52P or the radiation source 52A mounted to the capturing room R1 can be used.

According to the present embodiment, when data for the preview image is transmitted from the radiation image capturing apparatus 1, the console 58 generates the preview image based on the data and displays the image on the display section 58a. Then, the radiology technician checks the preview image to determine whether the object is captured in a normal position, whether or not capturing is necessary again, etc.

In the present embodiment, the console 58 also functions as an image processing apparatus. When the image data D, etc. is transmitted from the radiation image capturing apparatus 1, true image data D* is calculated based on the image data D, etc. Precise image processing such as gain correction processing, defective pixel correction processing, gradation processing according to the captured portion, etc. is performed on the calculated true image data D* to generate a final radiation image I.

### [Control Configuration for Detecting Start of Emission of Radiation in Radiation Image Capturing Apparatus]

Next, the control configuration for detecting processing of start of emission of radiation in the radiation image capturing apparatus 1 of the above configuration is described.

In the present embodiment, as described above, the radiation image capturing apparatus 1 itself can detect radiation is emitted from the radiation source 52 (see FIG. 11 and FIG. 12) of the radiation generating apparatus 55. Below, the method of detecting the start of emission of radiation performed in the radiation image capturing apparatus 1 of the present embodiment is described.

The detecting method described below is the detecting method newly discovered by the research by the inventors. For example, either of the two detecting methods can be employed.

### [Detecting Method 1]

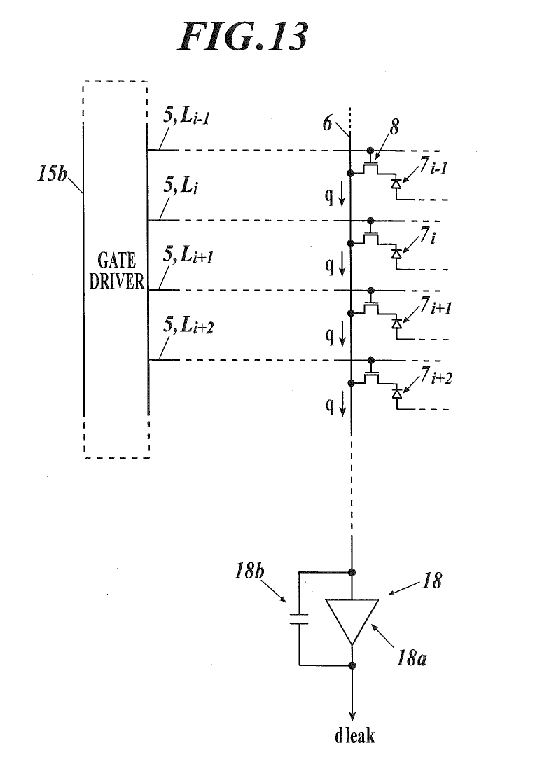

For example, it is possible to repeat reading processing of the leak data dleak before emission of radiation to the radiation image capturing apparatus 1 in the radiation image capturing. Here, as shown in FIG. 13, leak data dleak is data corresponding to a total value for each signal line 6 of charge q which leaks from each radiation detecting element 7 through each TFT 8 in an off state when in a state where the off voltage is applied to each scanning line 5.

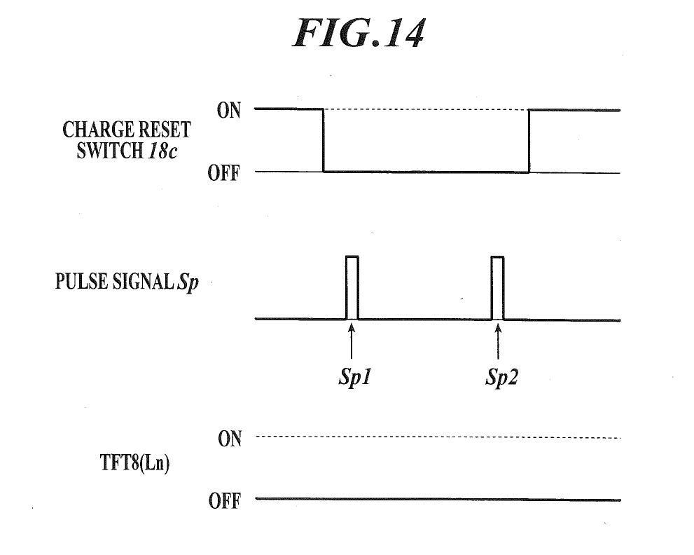

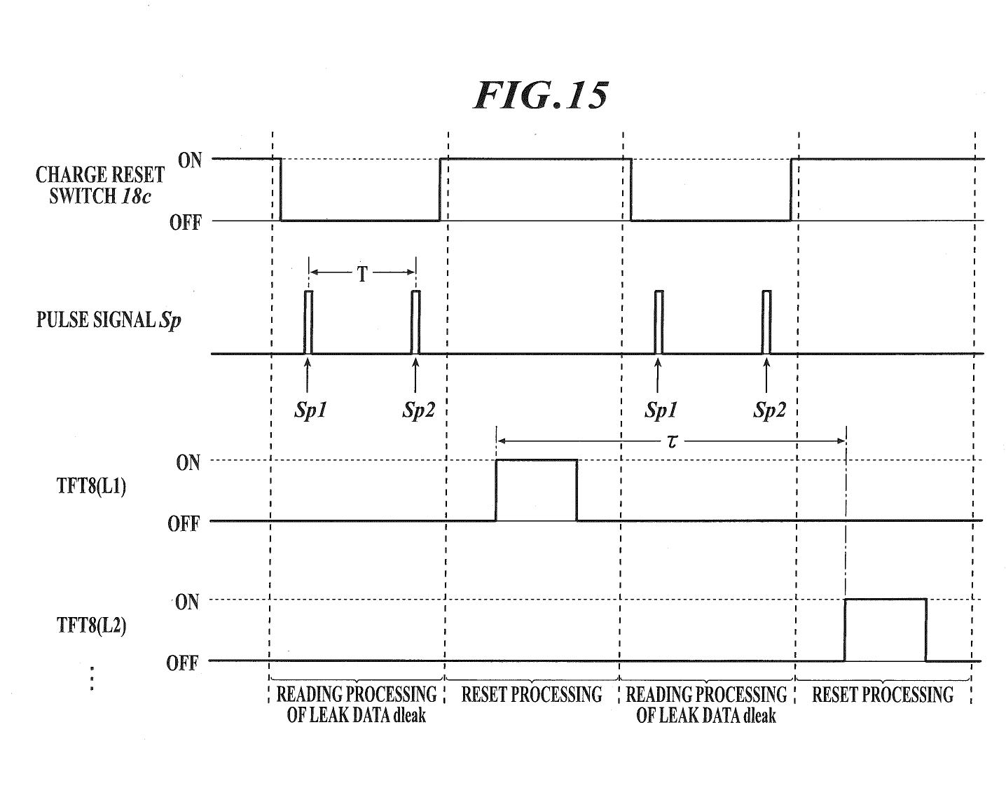

Then, different from the reset processing of each radiation detecting element 7 shown in FIG. 9, and the reading processing of the image data D shown in FIG. 10, in the reading processing of the leak data dleak, the pulse signals Sp1 and Sp2 are transmitted to the correlated double sampling amplifying circuit 19 (see CDS shown in FIG. 7 and FIG. 8) of each reading circuit 17 from the control section 22 in a state where the off voltage is applied to each line L1 to Lx of the scanning line 5 and each TFT 8 is in an off state as shown in FIG. 14.

When the pulse signal Sp1 is transmitted from the control section 22, the correlated double sampling amplifying circuit 19 maintains the voltage value Vin output from the amplifying circuit 18 at this point. Then, when the charge q which leaks from each radiation detecting element 7 through each TFT 8 is accumulated in the condenser 18b of the amplifying circuit 18, the voltage value output from the amplifying circuit 18 rises, and the pulse signal Sp2 is transmitted from the control section 22, the correlated double sampling amplifying circuit 19 maintains the voltage value Vfi output from the amplifying circuit 18 at this point.

Then, the value output from calculating the difference Vfi−Vin of the voltage value by the correlated double sampling amplifying circuit 19 is to be the leak data dleak. Similar to the reading processing of the image data D described above, the leak data dleak is then converted to a digital value in the A/D converter 20.

When only the reading processing of the leak data dleak is repeated, each TFT 8 remains in the off state, and the dark charge generated in each radiation detecting element 7 continues to be accumulated in each radiation detecting element 7.

Therefore, as described above, when the reading processing of leak data dleak is repeated before radiation image capturing, as shown in FIG. 15, it is preferable to alternately repeat the reading processing of the leak data dleak performed in a state where the off voltage is applied to each scanning line 5 and the reset processing of each radiation detecting element 7 where the on voltage is sequentially applied on each line L1 to Lx of the scanning line 5. T, τ, and Tac shown in FIG. 15 and later described 16 are described later.

In a case where the reading processing of leak data dleak and the reset processing of each radiation detecting element 7 are alternately repeated before radiation image capturing as described above, when the emission of radiation to the radiation image capturing apparatus 1 starts, the electromagnetic wave converted from the radiation in the scintillator 3 (see FIG. 2) is emitted to each TFT 8. Then, it is found by the research of the inventors that with this, the charge q (see FIG. 15) which leaks from each radiation detecting element 7 through each TFT 8 increases.

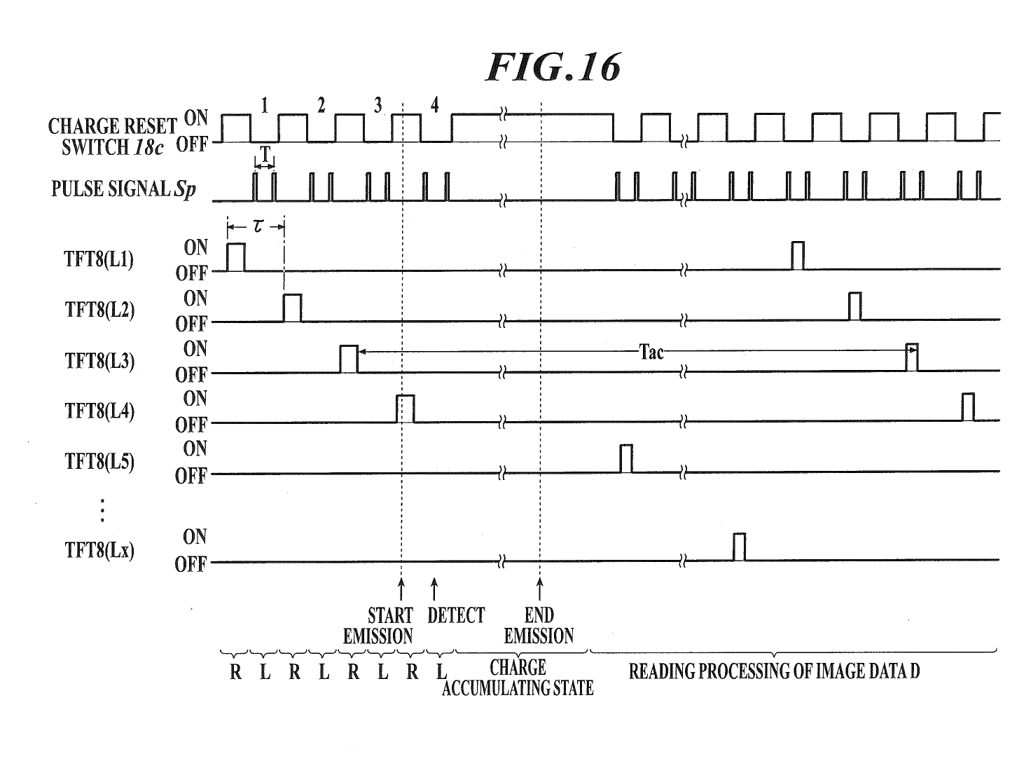

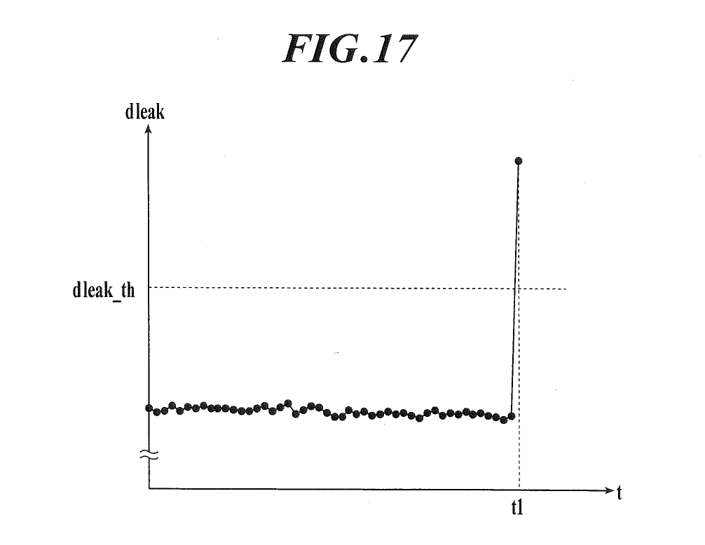

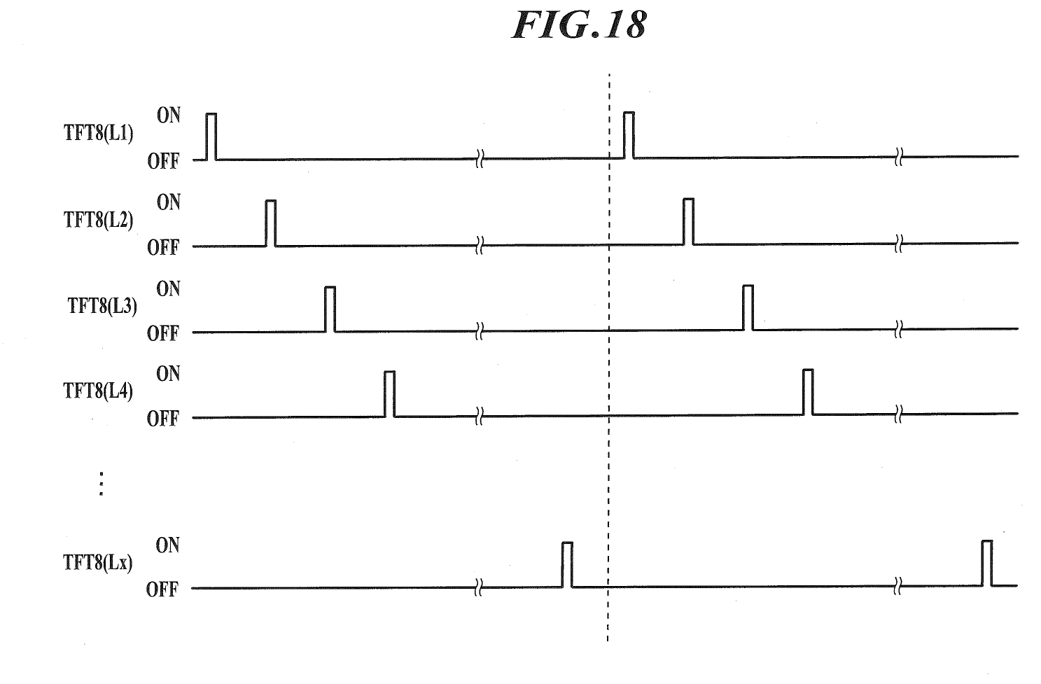

Then for example, as shown in FIG. 16, when the reading processing of the leak data dleak and the reset processing of each radiation detecting element 7 are repeated alternately before radiation image capturing, as shown in FIG. 17, the leak data dleak read at the point (see time t1) when emission of the radiation to the radiation image capturing apparatus 1 starts is a drastically larger value than the leak data dleak read before the above point.

In FIG. 16 and FIG. 17, the leak data dleak read in the fourth reading processing after the on voltage is applied to the line L4 of the scanning line 5 and the reset processing is performed as shown in FIG. 16 corresponds to the leak data dleak at time t1 shown in FIG. 17. In FIG. 16, “R” represents the reset processing of each radiation detecting element 7 and “L” represents the reading processing of leak data dleak.

It is possible that the control section 22 of the radiation image capturing apparatus 1 monitors the leak data dleak read in the reading processing of the leak data dleak before radiation image capturing and that the start of emission of radiation is detected at a point when the read leak data dleak exceeds, for example a predetermined threshold value dleak_th (see FIG. 17).

### [Detecting Method 2]

Instead of performing the reading processing of the leak data dleak before the radiation image capturing as shown in the above detecting method 1, it is possible to sequentially apply on voltage to each line L1 to Lx of the scanning line 5 from the gate driver 15b of the scanning driving section 15 to repeat reading processing of the image data d from each radiation detecting element 7 before radiation image capturing as shown in FIG. 18.

As described above, in order to distinguish from the image data D of the actual image after emitting radiation, the image data read for detecting start of emission of radiation before radiation image capturing is called emission start detecting image data d (or simply image data d).

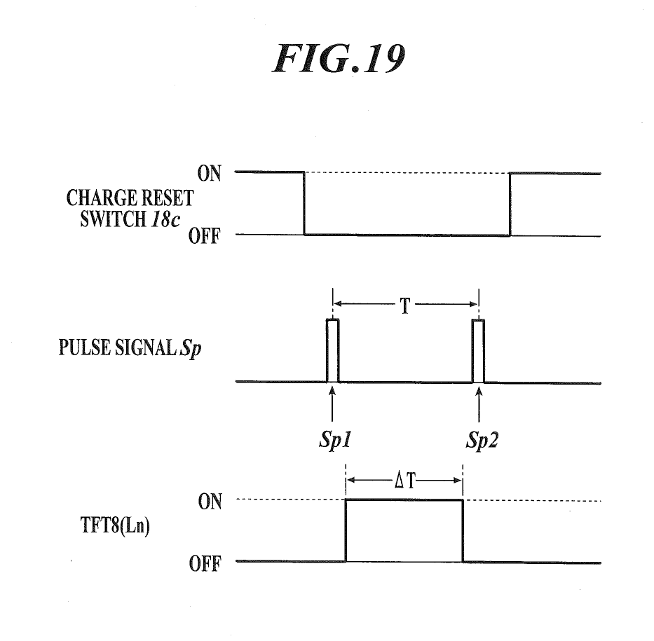

As shown in FIG. 19, on/off of the charge reset switch 18c of the amplifying circuit 18 of the reading circuit 17 and the transmission of the pulse signals Sp1 and Sp2 to the correlated double sampling amplifying circuit 19 in the reading processing of the emission start detecting image data d is performed similarly to the processing of the reading processing of the image data D shown in FIG. 10. T, ΔT shown in FIG. 19 is described later.

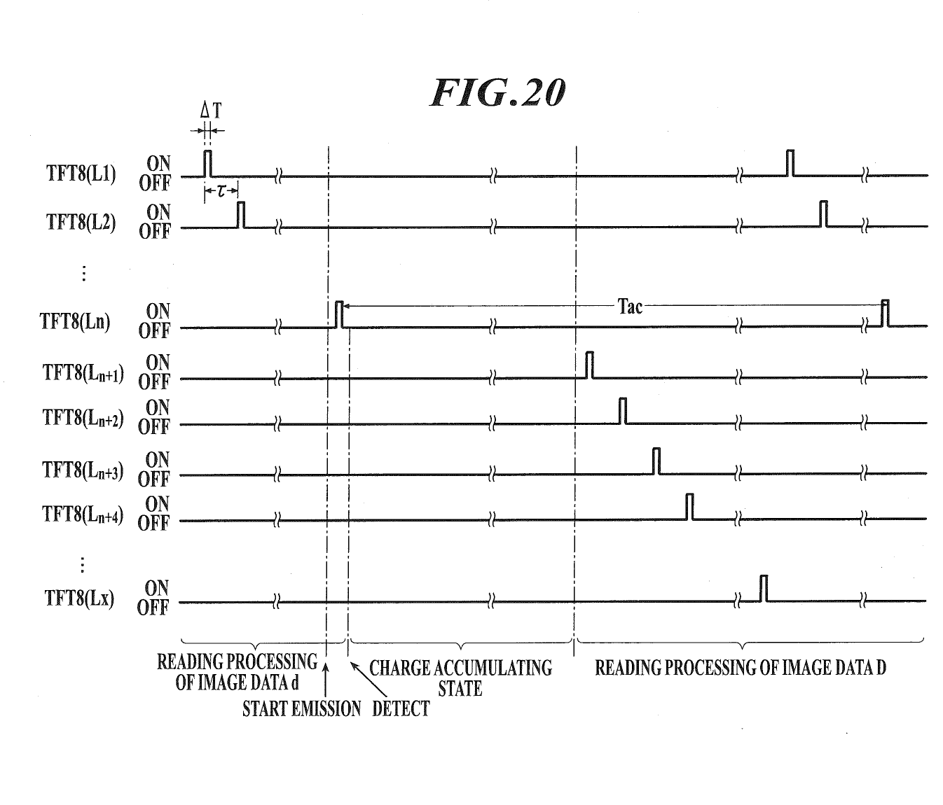

In a case where the reading processing of the emission start detecting image data d is performed before radiation image capturing, as shown in FIG. 20, when the emission of radiation on the radiation image capturing apparatus 1 starts, similar to the above described leak data Bleak shown in FIG. 17, the image data d read at this point (in FIG. 20 the image data d read by applying on voltage to the line Ln of the scanning line 5) becomes a value drastically larger than the image data d read before the above point.

It is possible that the control section 22 of the radiation image capturing apparatus 1 monitors the image data d read in the reading processing before radiation image capturing and that the start of emission of radiation is detected at the point of time when the read image data d exceeds the predetermined threshold value dth. ΔT, τ, Tac shown in FIG. 20 is described later.

### [Processing to Enhance Detection Sensitivity]

In the above described detecting method 1, when the cycle τ (see FIG. 15 and FIG. 16) from start of applying on voltage to a scanning line 5 to start of applying on voltage to the next scanning line 5 is long in the reset processing of each radiation detecting element 7 before radiation image capturing is long and transmission interval T of the two pulse signals Sp1 and Sp2 transmitted from the control section 22 in the reading processing of the leak data dleak is long, the value of the leak data dleak read in the reading processing of one leak data dleak becomes large. Therefore, the detection sensitivity of the start of emission of radiation in the radiation image capturing apparatus 1 is enhanced. The reset processing of each radiation detecting element 7 in which the cycle τ is long may be called a long cycle reset processing.

In the above described detecting method 2, when the time ΔT (see FIG. 19 and FIG. 20) in which each TFT 8 is in an on state, in other words, when the time Δ(hereinafter referred to as on time ΔT) from when the on voltage is applied to the scanning line 5 from the gate driver 15b of the scanning driving section 15 to when the voltage is switched to the off voltage is made long in the reading processing of emission start detecting image data d before radiation image capturing, the value of the image data d read in one reading processing of the image data d becomes large. Therefore, the detection sensitivity of the start of emission of radiation in the radiation image capturing apparatus 1 is enhanced.

In this case also, the cycle τ (see FIG. 20) from start of applying on voltage to a scanning line 5 to start of applying on voltage to the next scanning line 5, and the transmission interval T (see FIG. 19) of the two pulse signals Sp1 and Sp2 transmitted from the control section 22 becomes long.

When the above detecting method 1 or the detecting method 2 is employed, suitable processing to enhance detection sensitivity of the start of emission of radiation in the radiation image capturing apparatus 1 is performed, such as lengthening the cycle τ in the reset processing of each radiation detecting element 7 before radiation image capturing and the reading processing of the emission start detecting image data d, lengthening the transmission interval T of the two pulse signals Sp1 and Sp2 transmitted from the control section 22, or lengthening the on time ΔT.

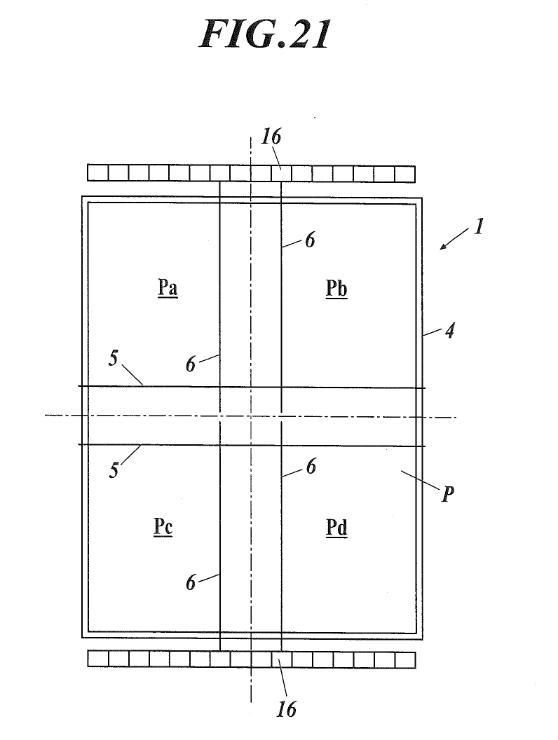

As shown in FIG. 21, the detecting section P may be defined in a plurality of regions such as defining the detecting section P (see FIG. 4, FIG. 7, etc.) into four regions Pa to Pd. In this case, it is possible to detect start of emission of radiation using the above detecting method 1 or the detecting method 2 for each region Pa to Pd of the detecting section P.

According to the above configuration, for example, even when the radiation is narrowly emitted to the radiation image capturing apparatus 1 and the radiation is emitted to only one or a few regions among the plurality of regions of Pa to Pd of the detecting section P, it is possible to accurately detect start of emission of radiation.

The above detecting method 1 and the detecting method 2 of the present embodiment can be modified to detect start of emission of radiation more accurately or more efficiently.

### [Other Detecting Methods]

The above described detecting method 1 and the detecting method 2 performs reading processing of leak data dleak and emission start detecting image data d before radiation image capturing and the start of emission of radiation is detected based on the value of the read leak data dleak or the emission start detecting image data d. However, it is possible to detect start of emission of radiation to the radiation image capturing apparatus by a detecting method other than the above.

For example, as described in the above Japanese Patent Application Laid-Open Publication No. 2009-219538, although illustration is omitted, it is possible to provide an electric current detecting section which detects the electric current which flows through a bias line 9 and connecting line 10 (see FIG. 7, etc.) in the radiation image capturing apparatus and the control section 22 of the radiation image capturing apparatus 1 detects the start of emission of radiation based on the electric current value detected by the electric current detecting section.

In this case, as described in Japanese Patent Application Laid-Open Publication No. 2009-219538, when the radiation is emitted to the radiation image capturing apparatus, the electric current value of the electric current which flows through the bias line 9 and the connecting line 10 drastically increases compared to the electric current value before. For example, it is possible to set a threshold value ith for the electric current value of the electric current which passes through the bias line 9 and the connecting line 10 and the start of emission of radiation on the radiation image capturing apparatus can be detected at the point of time when the electric current value i detected by the electric current detecting section exceeds the threshold value ith.

It is possible to provide a sensor in the radiation image capturing apparatus 1 which detects the amount of radiation emitted to the radiation image capturing apparatus 1 and the amount of light of the electromagnetic wave converted from the emitted radiation in the scintillator 3 of the radiation image capturing apparatus 1 so that the control section 22 of the radiation image capturing apparatus 1 can detect the start of emission of radiation based on the output value of the sensor, etc.

In each of the above cases, when shock or pressure is applied to the radiation image capturing apparatus, the output value, etc. of the electric current value i detected by the electric current detecting section, sensor, etc. may become large. Therefore, when shock or pressure is applied to the radiation image capturing apparatus, there is a possibility that the start of emission of radiation is falsely detected even when the radiation is not emitted to the radiation image capturing apparatus.

By applying the present invention in the radiation image capturing apparatus as described above, similar to the embodiment described below, it is possible to promptly return to a state to perform detecting processing of the start of emission of radiation (in other words, detecting processing of the electric current value i which flows through the bias line 9, etc. or detecting processing of the amount of radiation, etc. by the sensor, etc.) when the start of emission of radiation is falsely detected.

[Processing after Detecting Start of Emission of Radiation]

Next, in the present embodiment, when the start of emission of radiation is detected as described above, as described in FIG. 16 (case of detecting method 1) or FIG. 20 (case of detecting method 2), the control section 22 of the radiation image capturing apparatus 1 stops applying the on voltage to each scanning line 5 at the point when the start of emission of radiation is detected, applies the off voltage to all of the lines L1 to Lx of the scanning line 5 from the gate driver 15b and sets each TFT 8 to an off state.

When each TFT 8 is in an off state, the charge generated in each radiation detecting element 7 by emitting radiation to the radiation image capturing apparatus 1 is accumulated in the radiation detecting element 7. When the start of emission of radiation is detected, the control section 22 of the radiation image capturing apparatus 1 advances to the charge accumulating state.

When a predetermined amount of time passes from, for example, when the start of emission of radiation is detected, the control section 22 of the radiation image capturing apparatus 1 performs reading processing of the image data D.

In the present embodiment, the control section 22 starts applying on voltage from the scanning line 5 (line L5 of the scanning line 5 in FIG. 16) on which on voltage is to be applied next after the scanning line 5 (line L4 of the scanning line 5 in FIG. 16) on which on voltage is applied in the reset processing directly before the point of time when the start of emission of radiation is detected in the reading processing of the leak data dleak before the radiation image capturing. The on voltage is sequentially applied on each scanning line 5 to perform the reading processing of the image data D.

Similarly in the detecting method 2, as shown in FIG. 20, when a predetermined amount of time passes after detecting the start of emission of radiation, the control section 22 starts applying on voltage from the scanning line 5 (line Ln+1 of the scanning line 5 in FIG. 20) on which on voltage is to be applied next after the scanning line 5 (line Ln of the scanning line 5 in FIG. 20) on which on voltage is applied at the point of time when the start of emission of radiation is detected in the reading processing of the emission start detecting image data d before radiation image capturing. The on voltage is sequentially applied to each scanning line 5 to perform the reading processing of the image data D.

In the present embodiment, the on voltage is sequentially applied on each scanning line 5 so that the cycle of applying on voltage to each scanning line 5 from the gate driver 15b in the reading processing of the image data D is the same as the cycle τ of the reset processing of each radiation detecting element 7 performed alternately with the reading processing of the leak data dleak before radiation image capturing (in the case of the detecting method 1, see FIG. 16, etc.) or the reading processing of the emission start detecting image data d (in the case of the detecting method 2, see FIG. 20).

With such configuration, there is a merit that the time Tac (see FIG. 16 and FIG. 20) from switching the on voltage applied to the scanning line 5 before advancing to the charge accumulating state before reading processing of the image data D to the off voltage to switching the on voltage applied to the scanning line 5 in the reading processing of the image data D after the voltage charging state to the off voltage becomes the same time in each scanning line 5.

When the reading processing of the image data D as the actual image is performed, as described above, the control section 22 of the radiation image capturing apparatus 1 transmits data for the preview image to the console 58 through the communication section of the antenna apparatus 41, etc. Then, the console 58 generates the preview image based on the transmitted preview image data and displays the preview image on the display section 58a.

The transmitting processing of the preview image data can be performed after the reading processing of the offset data O described below ends.

Although illustration is omitted, in the present embodiment, the control section 22 of the radiation image capturing apparatus 1 then performs the reading processing of the offset data O.

As described above, in each radiation detecting element 7, dark charge (also called dark electric current, etc.) is constantly generated due to thermal excitation, etc. by the heat (temperature) of each radiation detecting element 7 itself. The offset amount due to the dark charge generated and accumulated while the TFT 8 is in an off state until before the reading processing of the image data D (in other words, during the above described time Tac) is overlapped on the image data D read in the reading processing of the image data D.

The reading processing of the offset data O to read the offset amount due to the dark charge as the offset data O is typically performed before or after the reading processing of the image data D. In the present embodiment, the processing sequence which is the same as the processing sequence until the reading processing of the image data D shown in FIG. 16 and FIG. 20 is repeated to perform the reading processing of the offset data O. In the reading processing of the offset data O, the radiation is not emitted to the radiation image capturing apparatus 1.

When the reading processing of the offset data O ends as described above, the control section 22 of the radiation image capturing apparatus 1 transmits the remaining image data D other than the image data D transmitted as the preview image data and the offset data O to the console 58.

In the console 58, when the image data D and the offset data O are transmitted from the radiation image capturing apparatus 1, the offset data O is subtracted from the image data D to calculate the true image data D* for each radiation detecting element 7 of the radiation image capturing apparatus 1. Then, as described above, precise image processing such as gain correction processing, defective pixel correction processing, gradation processing according to the captured portion, etc. is performed on the calculated true image data D* to generate a final radiation image I.

### [Sequence, etc. of Radiation Image Capturing in Present Invention]

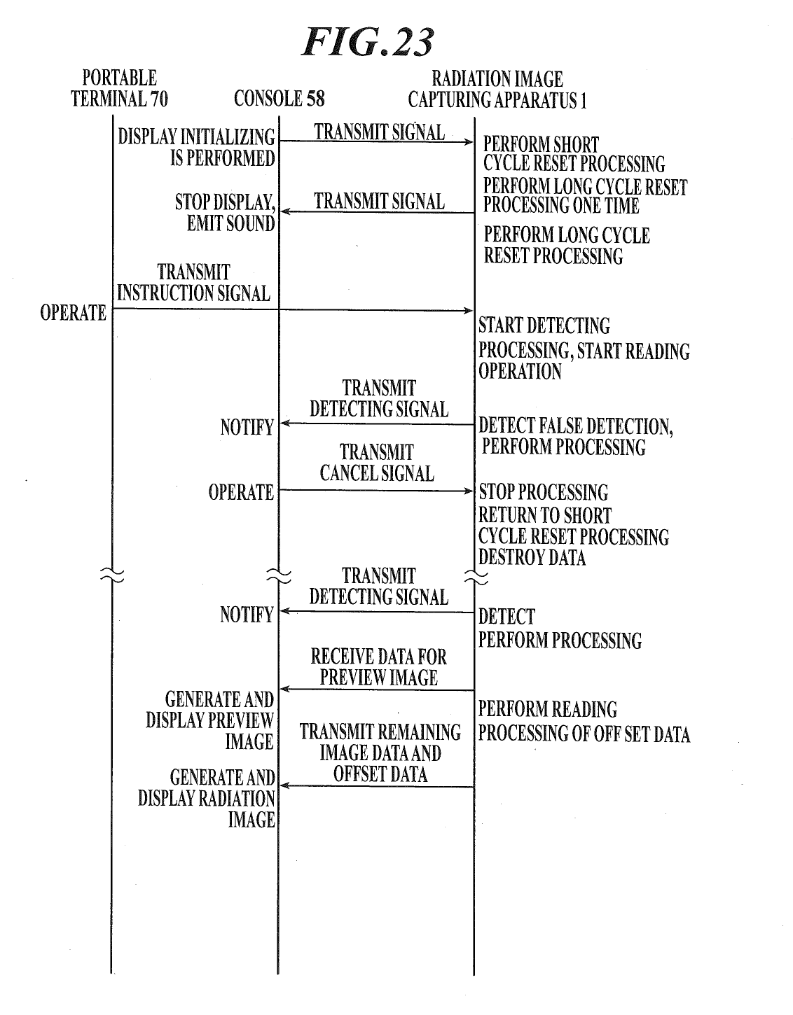

Next, the sequence, processing, etc. of the radiation image capturing in the radiation image capturing apparatus 1 and the radiation image capturing system 50 of the present embodiment is described based on the sequential diagram shown in FIG. 23. The operation of the radiation image capturing apparatus 1 and the radiation image capturing system 50 of the present embodiment is also described.

The example below describes a case employing the above described detecting method 1, in other words, alternately performing the reading processing of the leak data dleak and the reset processing of the radiation detecting element 7 before radiation image capturing to detect the start of emission of radiation based on the read leak data dleak and the values calculated based on the above data. However, the description similarly applies to the example employing the above described detecting method 2, etc.

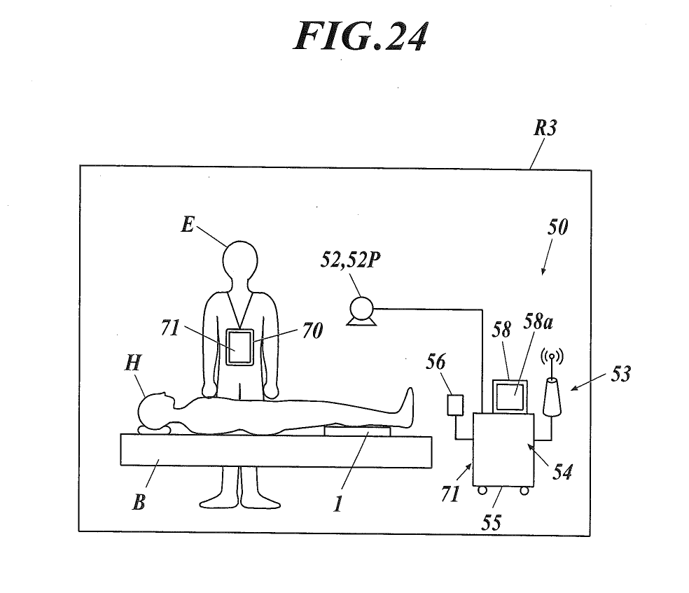

Described below is an example where a later described portable terminal 70 (see later described FIG. 24) functions as a later described instruction signal transmitting section, and the console 58 functions as the later described notifying apparatus. The configuration of the instruction signal transmitting section and the notifying apparatus is described later.

### [Reset Processing of Each Radiation Detecting Element]

For example, in the present embodiment, when the signal to start radiation image capturing is transmitted to the radiation image capturing apparatus 1 from the console 58, the control section 22 of the radiation image capturing apparatus 1 first performs the reset processing of each radiation detecting element 7 to remove the excess charge remaining in each radiation detecting element 7.

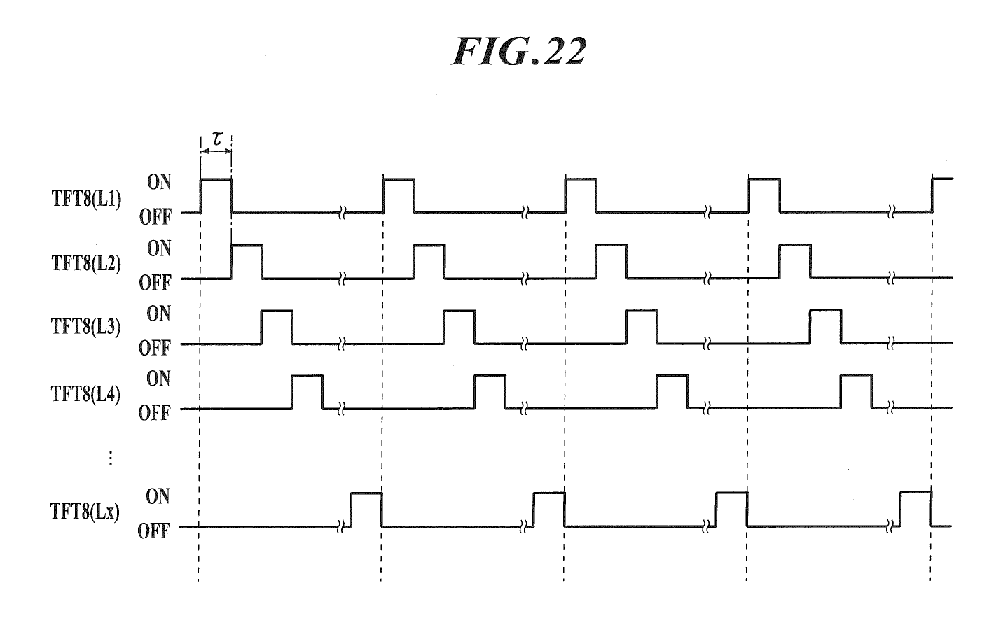

The reset processing in this case can be the long cycle reset processing where the cycle τ (see FIG. 15, FIG. 16, etc.) to alternately perform the reading processing of the leak data dleak before radiation image capturing as described above is long. In the present embodiment, in order to promptly remove the remaining charge, for example, as shown in FIG. 22, the normal short cycle reset processing are repeated a predetermined number of times, where the cycle τ which sequentially applies on voltage to the line L1 to Lx of the scanning line 5 from the gate driver 15b of the scanning driving section 15 is short.

The predetermined number of times here does not need to be four times or more as shown in FIG. 22, and can be one or two times. The number of times is suitably set.

### [Not Performing Detecting Operation of Start of Emission of Radiation for a Period of at Least One Time]

After the reset processing of the short cycle ends, the control section 22 of the radiation image capturing apparatus 1 advances to the detecting processing of the start of emission of radiation as described above.

However, in the present embodiment, the control section 22 does not perform the detecting operation of the start of emission of radiation during a period of the detecting processing of one time directly after the short cycle reset processing ends and the processing advances to the detecting processing (in other words, while on voltage is applied once each time to each line L1 to Lx of the scanning line 5 in the reading processing of the leak data dleak and the alternately performed long cycle reset processing (see FIG. 15 and FIG. 16)).

The reason for the above configuration is described below. In other words, according to the research by the inventors, it is known that the value of the leak data dleak read in the reading processing (or the reading processing of the emission start detecting image data d, the same shall apply hereinafter) of the leak data dleak directly after advancing from the typical short cycle reset processing to the detecting processing becomes large.

The reason why the above occurs is not clearly understood. One reason may be that when reset processing is performed in the short cycle, a relatively large amount of charge is trapped in the trap level in each TFT 8 when the charge is discharged from each radiation detecting element 7 to the signal line 6. In the initial stage of the reading processing of the leak data dleak, the amount of charge in each TFT 8 which discharges to the signal line 6 together with the charge q (see FIG. 13) which leaks from the radiation detecting element 7 through the TFT 8 to the signal line 6 becomes large. Therefore, it is considered that the value of the leak data dleak becomes large.

When such phenomenon occurs, when the detecting operation is performed directly after advancing from the normal short cycle reset processing to the detecting processing, the leak data dleak with a large value read directly after advancing to the detecting processing exceeds the threshold value dleak_th, and there is a possibility of falsely detecting that the emission of radiation to the radiation image capturing apparatus 1 starts.

However, as the reading processing of the leak data dleak and the reset processing (see FIG. 15 and FIG. 16) of each radiation detecting element 7 of the long cycle τ is repeated, the amount of charge trapped in each TFT 8 reduces. Therefore, as the reading processing of the leak data dleak is repeated, the value of the read leak data dleak converges to a normal relatively small value.

As described above, in the present embodiment, the control section 22 of the radiation image capturing apparatus 1 does not perform the detecting operation of start of emission of radiation (in other words reading operation of leak data dleak) during the period that the detecting processing is performed one time directly after advancing to the detecting processing of start of emission of radiation from the short cycle reset processing.

Specifically, when the above detecting method 1 is employed as the method of detecting processing of start of emission of radiation, during this period, the control section 22 of the radiation image capturing apparatus 1 does not perform reading processing of the leak data dleak and only performs long cycle reset processing of each radiation detecting element 7.

When the above detecting method 2 is employed as the method of detecting processing of start of emission of radiation, during this period, the control section 22 of the radiation image capturing apparatus 1 performs the reset processing of each radiation detecting element 7 at the same cycle τ instead of performing reading processing of the emission start detecting image data d.

In the present embodiment, after advancing from the short cycle reset processing to the detecting processing of start of emission of radiation, the leak data dleak (or emission start detecting image data d, the same shall apply hereinafter) read in the detecting processing after the second detecting processing becomes a normal relatively small value. Therefore, the detecting operation is not performed during the period of performing the detecting processing one time directly after advancing to the detecting processing. However, when the period for the leak data dleak to converge to a normal small value becomes long, the number of times that the detecting operation is not performed can be increased.

When the read leak data dleak does not become a large value even when the leak data dleak is read directly after advancing from the short cycle reset processing to the detecting processing and the leak data dleak with a normal relatively small value is read from the beginning, the operation of detecting the start of emission of radiation (in other words, reading operation of the leak data dleak, comparison processing between the data and the threshold value and the like) can be performed from directly after advancing to the detecting processing.

In the radiation image capturing apparatus 1 of the present embodiment, as described above, while the short cycle reset processing (see FIG. 22) is performed, or while the detecting operation is not performed one time, the start of emission of radiation cannot be detected. For example, as shown in FIG. 23, during the above period, it is possible to display on the display section 58a of the console 58 with color or characters that the radiation image capturing apparatus 1 is initializing by performing reset processing of each radiation detecting element 7 in a short cycle or a long cycle and the like.

Then, at the point when the period of performing the short cycle reset processing or the period of not performing the detecting processing for one time ends, the radiation image capturing apparatus 1 can transmit a signal to the console 58 which shows that it is possible to advance to the detecting processing of start of emission of radiation by starting the reading processing of the leak data dleak, etc. In this case, when the signal is transmitted from the radiation image capturing apparatus 1, the console 58 stops or deletes the above display, or emits sound to notify the radiology technician that the radiation image capturing apparatus 1 is in the above state.

### [Processing to Instruct Start of Detecting Processing]

In the present embodiment, as described above, even when the period that the short cycle reset processing is performed a predetermined number of times or when the period of not performing the detecting operation one time ends, the control section 22 of the radiation image capturing apparatus 1 does not immediately start the reading processing of the leak data dleak and only continues to perform the long cycle reset processing. In other words, the detecting processing of start of emission of radiation is not started immediately.

Therefore, while the radiation image capturing apparatus 1 performs the short cycle reset processing a predetermined number of times or while the radiation image capturing apparatus 1 does not perform the detecting operation one time, for example, the radiology technician can position the radiation image capturing apparatus 1 by inserting the radiation image capturing apparatus 1 between the bed B and the body of the patient H (see FIG. 12, etc.) or by placing the radiation image capturing apparatus 1 directly against the body of the patient.

While the short cycle reset processing is performed a predetermined number of times or while the detecting operation is not performed one time, the positioning is not completed, and the positioning of the radiation image capturing apparatus 1 may still be performed at the point when the radiation image capturing apparatus 1 finishes the period of not performing the detecting operation one time.

In such a case, if the radiation image capturing apparatus 1 starts the detecting processing of the start of emission of radiation, the body of the patient may collide against the radiation image capturing apparatus 1 or strong pressure may be applied from the body of the patient to the radiation image capturing apparatus 1 when the radiation image capturing apparatus 1 is positioned. Therefore, as described above, the value of the read leak data dleak (or the emission start detecting image data d, the same shall apply hereinafter) may become large, and the possibility of false detection of start of emission of radiation increases.

Therefore, in the present embodiment, in order to prevent such false detection, even when the short cycle reset processing performed a predetermined number of times ends, the radiation image capturing apparatus 1 does not immediately advance to the detecting processing of start of emission of radiation and repeats only the long cycle reset processing without performing the reading operation of the leak data dleak until the radiology technician transmits an instruction signal instructing to start the detecting processing after the positioning of the radiation image capturing apparatus 1 completes, etc.

In the present embodiment, as shown in FIG. 24, the radiology technician E carries the portable terminal 70. After the radiology technician E finishes positioning the radiation image capturing apparatus 1, the radiology technician E operates the portable terminal 70 to transmit the above instruction signal directly to the radiation image capturing apparatus 1 or to the radiation image capturing apparatus 1 through the console 58. Therefore, in the present embodiment, the portable terminal 70 functions as the instruction signal transmitting section.

For example, the radiology technician E can operate the console 58 to transmit the instruction signal after finishing positioning of the radiation image capturing apparatus 1. In this case, the console 58 functions as the instruction signal transmitting section which can transmit the above instruction signal to the radiation image capturing apparatus 1.

After the radiology technician E finishes positioning, etc. of the radiation image capturing apparatus 1, the radiology technician E can operate the switching switch 38 (see FIG. 1, etc.) of the radiation image capturing apparatus 1 to input the instruction signal directly to the radiation image capturing apparatus 1. In this case, the switching switch 38, etc. functions as the instruction signal transmitting section.

When the instruction signal is received from the instruction signal transmitting section, as shown in FIG. 23, at this point, the radiation image capturing apparatus 1 advances from a state performing only the long cycle reset processing to the detecting processing of start of emission of radiation which alternately repeats the reading operation of the leak data dleak and the reset processing of the long cycle of each radiation detecting element 7, and starts the above described detecting processing which detects the start of emission of radiation based on the read leak data dleak.

In other words, in the present embodiment, after the period of performing the short cycle reset processing a predetermined number of times and the period of not performing the detecting operation one time passes, before receiving the instruction signal from the instruction signal transmitting section, as described above, the radiation image capturing apparatus 1 maintains a state of performing only the long cycle reset processing of each radiation detecting element.

When the above instruction signal is received from the instruction signal transmitting section, at this point, the radiation image capturing apparatus 1 advances to the detecting processing (see FIG. 15, etc.) of start of emission of radiation which alternately repeats reading operation of the leak data dleak and the long cycle reset processing of each radiation detecting element 7.

When the detecting method 2 is employed (see FIG. 18, FIG. 20, etc.), at this point, the processing advances from the state performing reset processing of each radiation detecting element 7 to the state performing reading processing of the emission start detecting image data d. The detecting processing of start of emission of radiation is performed in the method described above, including when the detecting method 2 is employed.

According to the above configuration, even if the body of the patient collides to the radiation image capturing apparatus 1 or the radiation image capturing apparatus 1 receives strong pressure from the body of the patient when positioning the radiation image capturing apparatus 1 before transmitting the instruction signal, the radiation image capturing apparatus 1 is not performing the detecting processing of start of emission of radiation. Therefore, the false detection of the start of emission of radiation can be accurately prevented.

Until the instruction signal is transmitted, the reading operation of leak data dleak, etc. which consumes relatively large amount of electric power is not performed and there is a merit that it is possible to suppress consumption of electric power.

For example, in this case, at the point when the radiation image capturing apparatus 1 starts the detecting processing of start of emission of radiation (in other words, at the point when the instruction signal is received), the radiation image capturing apparatus 1 can transmit the signal showing that the detecting processing of start of emission of radiation starts to the console 58 to display that the above processing starts on the display section 58a of the console 58.

The instruction signal may be transmitted from the portable terminal 70, etc. while the radiation image capturing apparatus 1 performs the short cycle reset processing a predetermined number of times, or the radiation image capturing apparatus 1 does not perform the detecting operation one time. In such case, the control section 22 of the radiation image capturing apparatus 1 immediately advances to the detecting processing of start of emission of radiation at the point when the period of performing the short cycle reset processing or the period when the detecting operation is not performed once ends.

[Processing when Start of Emission of Radiation is Detected]

When the radiation image capturing apparatus 1 receives the instruction signal from the instruction signal transmitting section as described above, the radiation image capturing apparatus 1 starts the detecting processing of the start of emission of radiation at this point.

In the present embodiment, when the start of emission of radiation is detected by the read leak data dleak exceeding the threshold value dleak_th or the like as described above, the control section 22 of the radiation image capturing apparatus 1 transmits a detecting signal showing that the start of emission of radiation is detected through the communication section such as the antenna apparatus 41, etc. to the notifying apparatus of the radiation image capturing system 50.

In the present embodiment, the radiation image capturing system 50 includes a notifying section which notifies to the radiology technician by sound or display. When the notifying apparatus receives the above detecting signal from the radiation image capturing apparatus 1, the notifying section emits sounds or performs display from the notifying section to notify to the radiology technician that the radiation image capturing apparatus 1 detected start of emission of radiation.

In the present embodiment, as described above, the console 58 functions as the notifying apparatus, and the display section 58a and the speaker of the console 58 functions as the notifying section. When the detecting signal is received from the radiation image capturing apparatus 1, the console 58 as the notifying apparatus emits a buzzer sound from the speaker or displays that the radiation image capturing apparatus 1 detected start of emission of radiation on the display section 58a to notify to the radiology technician.

For example, a display section 71, a speaker (not illustrated), etc. can be provided on the portable terminal 70 shown in FIG. 24, and the portable terminal 70 can function as the notifying apparatus. In this case, the display section 71 and the speaker function as the notifying section.

Instead of configuring the console 58 and the portable terminal 70 to function as the notifying apparatus, the radiation image capturing apparatus 1 itself can notify the start of emission of radiation is detected. For example, in this case, the speaker provided in the radiation image capturing apparatus 1 emits sound, the indicator 40 (see FIG. 1) is lit with a predetermined blink or color to notify by sound or display that the start of emission of radiation is detected. In other words, the indicator 40 and the speaker function as the notifying section.

According to a configuration where a detecting signal is transmitted to the notifying section when the radiation image capturing apparatus 1 detects start of emission of radiation, and the notifying apparatus notifies that the start of emission of radiation is detected by the radiation image capturing apparatus 1, the following advantageous effects can be achieved.

In other words, as described above, the radiology technician operates the exposure switch 56 (see FIG. 11 or FIG. 12) of the radiation generating apparatus 55 to emit radiation from the radiation source 52 to the radiation image capturing apparatus 1. When the radiology technician is notified by the notifying apparatus that the radiation image capturing apparatus 1 detected the start of emission of radiation simultaneously to or directly after the radiology technician operates the exposure switch 56 to emit radiation from the radiation source 52, the radiology technician can judge that the radiation image capturing apparatus 1 normally detected the start of emission of radiation.

If the radiology technician is notified from the notifying apparatus that the start of emission of radiation is detected by the radiation image capturing apparatus 1 when the exposure switch 56 is not operated, the radiology technician can judge that the radiation image capturing apparatus 1 falsely detected the start of emission of radiation.

Since the notifying apparatus notifies that the start of emission of radiation is detected by the radiation image capturing apparatus 1 when the radiation image capturing apparatus 1 detects the start of emission of radiation, the radiology technician can accurately judge whether the detection of the start of emission of radiation by the radiation image capturing apparatus 1 is a normal detection or a false detection.

When the radiation image capturing apparatus 1 falsely detects the start of emission of radiation, the radiation image capturing apparatus 1 automatically advances to the following charge accumulating state, performs the reading processing of the image data D, and the like. Since the radiology technician does not know which processing is performed at present in the radiation image capturing apparatus 1 after false detection, the radiology technician does not emit radiation on the radiation image capturing apparatus 1 in such state.

When the radiation image capturing apparatus 1 falsely detects the start of emission of radiation, the radiology technician can accurately prevent emitting radiation on the radiation image capturing apparatus 1 which falsely detected the start of emission of radiation. Moreover, it is possible to prevent emitting unnecessary radiation on the radiation image capturing apparatus 1 in the above state. Therefore, it is possible to accurately prevent increasing the amount of radiation on the body of the patient who is the object.

The exposure switch 56 (see FIG. 11 or FIG. 12) is typically a two step stroke configuration and it is possible to provide a function of notifying by sound when the radiology technician presses in the amount of the first stroke. Therefore, when the detecting signal from the radiation image capturing apparatus 1 which detected the start of emission of radiation is transmitted, and the notification is made by sound from the speaker of the console 58 or the portable terminal 70 (see FIG. 24) held by the radiology technician, the radiology technician in the front room R2 to operate the exposure switch 56 can hear the sound from the notifying section after the sound emitted with the operation of the exposure switch 56.

Therefore, in this case, it is preferable to set the time of maintaining the sound from the notifying apparatus such as the console 58, portable terminal 70, etc. based on the detecting signal from the radiation image capturing apparatus 1 longer (for example so that the amount of time is a few times larger) than the time of maintaining the sound from the exposure switch 56 so that both sounds are not mixed.

As described above, when the radiation image capturing apparatus 1 transmits the signal which shows the state that it is possible to advance to the detecting processing of start of emission of radiation and the console 58 emits sound according to the signal, three types of sound including the above two types of sound are mixed. Therefore, it is preferable to be able to control the various sound so that the radiology technician can distinguish and understand the sound (in other words, control such as changing the maintaining time of sound, notifying content by words, etc.).

When the sound notifying function is not applied with the operation of the exposure switch 56 (see FIG. 11 or FIG. 12), two types of notification by sound is performed which are sound notification with the console 58 when the radiation image capturing apparatus 1 transmits the signal showing that it is possible to advance to the detecting processing of start of emission of radiation and the sound notification with the console 58 or the portable terminal 70 when the radiation image capturing apparatus 1 transmits the detecting signal that the start of emission of radiation is detected.

In this case, considering the capturing flow by the radiology technician, it is preferable that the sound notification showing that it is possible to advance to the detecting processing is performed by the portable terminal 70 or the radiation image capturing apparatus 1 itself, and that the notification of detecting the start of emission of radiation is performed by the console 58 or the portable terminal 70. According to such configuration, considering the movement between the capturing room R1 and the front room R2, the radiology technician can reliably understand the notification by sound.

As described above, when the notifying apparatus notifies that the radiation image capturing apparatus 1 detected the start of emission of radiation even when the radiology technician does not operate the exposure switch 56, since the exposure switch 56 is not operated, the confusion with the operation sound of the exposure switch 56 does not occur.

However, there is the possibility that the radiology technician is in the capturing room R1, and in this case, it is not possible to hear the notification by sound from the console 58. Therefore, when there is a notification by sound with the transmission of the detecting signal from the radiation image capturing apparatus 1 which detected the start of the emission of radiation (in this case false detection), it is preferable that both the console 58 (or the front room R2) and the radiation image capturing apparatus 1 (or the capturing room R1) perform the notification.

As described above, in the present invention, basically, the radiation image capturing apparatus 1 does not perform transmission of signals, etc. between the radiation generating apparatus 55 (see FIG. 11 or FIG. 12) and detects the start of emission of radiation with the radiation image capturing apparatus 1 itself to perform radiation image capturing.

However, it is not limited to a capturing method which performs capturing without cooperation with the radiation generating apparatus 55 (non-cooperating method), and it is possible to perform capturing by a cooperating method in which radiation image capturing is performed while transmitting signals and information between the radiation image capturing apparatus 1 and the radiation generating apparatus 55 as in conventional methods.

When the radiation image capturing is performed by a cooperating method, in other words, for example the radiology technician operates the console 58 to select the cooperating method as the capturing method, it is preferable to control to not perform the above two type of notification by sound, which are the sound notification with the console 58 when the radiation image capturing apparatus 1 transmits the signal showing that it is possible to advance to the detecting processing of the start of emission of radiation and the sound notification with the console 58 or the portable terminal 70 when the detecting signal is transmitted from the radiation image capturing apparatus 1 which detected the start of the emission of radiation.

[Processing when Start of Emission of Radiation is Falsely Detected]

Described below is the processing when the radiation image capturing apparatus 1 falsely detects the start of emission of radiation.

As shown in the middle of FIG. 23, even when the radiation image capturing apparatus 1 falsely detects start of emission of radiation, the radiation image capturing apparatus 1 cannot judge whether the detection is a normal detection or a false detection. Therefore, similar to the above, the radiation image capturing apparatus 1 transmits a detecting signal which shows that the start of emission of radiation is detected to the console 58 which is the notifying apparatus of the present embodiment.

When the console 58 which is the notifying apparatus notifies by sound or display that the radiation image capturing apparatus 1 detected the start of the emission of radiation, as described above, the radiology technician judges that the radiation image capturing apparatus 1 falsely detected the start of emission of radiation since the exposure switch 56 is not operated.

In this case, when the processing such as advancing to the charge accumulating state, reading processing of image data D, and the later performed reading processing of offset data O is performed in the radiation image capturing apparatus 1 which falsely detected the start of emission of radiation, the read image data D, etc. cannot be used and electric power is wasted. The patient who is the object needs to wait a long period of time until the above processing ends and the burden on the patient increases.

In the present embodiment, when the radiation image capturing apparatus 1 falsely detects the start of emission of radiation, the radiology technician forcibly ends the processing of the radiation image capturing apparatus 1.

Specifically, for example, the console 58 or the portable terminal 70 functions as the cancel signal transmitting section (or the switching switch 38, etc. of the radiation image capturing apparatus 1 can function as the cancel signal transmitting section) and when the radiology technician judges that the radiation image capturing apparatus 1 falsely detected the start of emission of radiation, the radiology technician operates the cancel signal transmitting section and transmits a cancel signal to the radiation image capturing apparatus 1 instructing the processing being performed to be stopped.

When the radiation image capturing apparatus 1 receives the cancel signal, the processing performed at this point is stopped. Since there is a possibility that charge such as dark charge, etc. is accumulated in each radiation detecting element 7, in the present embodiment, the radiation image capturing apparatus 1 returns to the state of performing the above short cycle reset processing (see top of FIG. 23).

For example, in this case, the control section 22 of the radiation image capturing apparatus 1 recognizes whether or not the image data D or the offset data O is read when the cancel signal is received. The read data in the present false detection is unnecessary data.

Therefore, in the present embodiment, the control section 22 returns the processing to the state of performing reset processing of each radiation detecting element and also destroys data when image data D or offset data O obtained in the processing up to this point is stored in the storage section 23 (see FIG. 7, etc.).

In the present embodiment, when the radiation image capturing apparatus 1 receives a cancel signal, as described above, the processing returns to the state of performing the short cycle reset processing (see top of FIG. 23). Therefore, the instruction signal needs to be transmitted again from the instruction signal transmitting section such as the portable terminal 70, etc. in order to allow the radiation image capturing apparatus 1 to perform the detecting processing of start of emission of radiation.

As described above, the radiology technician judges that the radiation image capturing apparatus 1 normally detected start of emission of radiation when the console 58 which is the notifying apparatus notifies that the radiation image capturing apparatus 1 detected start of emission of radiation simultaneously to or directly after the radiology technician operates the exposure switch 56 of the radiation generating apparatus 55 and radiation is emitted from the radiation source 52 to the radiation image capturing apparatus 1.

In this case, as shown in the bottom of FIG. 23, the radiology technician does not operate the console 58 or the radiation image capturing apparatus 1 and leaves them as is to allow the radiation image capturing apparatus 1 to automatically perform each processing such as reading processing of the image data D. In other words, processing such as transmitting the cancel signal to the radiation image capturing apparatus 1 is not performed.

When the radiation image capturing apparatus 1 detects the start of emission of radiation as shown in FIG. 16, FIG. 20, etc. the radiation image capturing apparatus 1 performs the reading processing of the image data D after advancing to the charge accumulating state. Then, the control section 22 of the radiation image capturing apparatus 1 transmits the preview image data to the console 58 and the console 58 generates the preview image based on the transmitted preview image data and displays the image on the display section 58a.

As described above, the radiology technician confirms the preview image displayed on the display section 58a of the console 58 to judge whether or not capturing needs to be performed again. When it is judged that capturing needs to be performed again, the radiation image capturing apparatus 1 stops the later processing and the processing is returned to the state to perform the short cycle reset processing.

When the preview image data is transmitted, then the control section 22 of the radiation image capturing apparatus 1 performs the reading processing of the offset data O. Then, the remaining image data D other than the image data D transmitted as the preview image data and the offset data O are transmitted to the console 58.

Then, when the image data D, etc. is transmitted from the radiation image capturing apparatus 1, the console 58 calculates the true image data D* based on the image data D, etc. and performs precise image processing such as gain correction processing, defective pixel correction processing, gradation processing according to capturing portion on the calculated true image data D* to generate the final radiation image I. In the present embodiment, the radiation image capturing is performed in the above method.

As described above, according to the radiation image capturing system 50 and the radiation image capturing apparatus 1 of the present embodiment, when the start of emission of radiation is detected, the control section 22 of the radiation image capturing apparatus 1 notifies the start of emission of radiation is detected or transmits a detecting signal to the notifying apparatus such as the console 58, etc. to notify that the start of the emission of radiation is detected by the radiation image capturing apparatus 1.

Therefore, the radiology technician can accurately understand whether the radiation image capturing apparatus 1 detected the start of emission of radiation due to operation of the exposure switch 56 (in other words, normal detection), or the radiation image capturing apparatus 1 detected the start of emission of radiation even when the radiation is not emitted (in other words false detection).

When the radiology technician judges that the radiation image capturing apparatus 1 falsely detected the start of emission of radiation because the radiation is not emitted, the radiology technician does not emit radiation to the radiation image capturing apparatus 1 so that it is possible to accurately prevent radiation being emitted to the radiation image capturing apparatus 1 which is performing processing based on false detection.

Even if radiation is emitted to the radiation image capturing apparatus 1 performing processing based on false detection, it is necessary to perform capturing again. Therefore, it is possible to accurately prevent the amount of radiation to the body of the patient who is the object increasing due to radiation being emitted again.

According to the present embodiment, when the radiology technician recognizes that the radiation image capturing apparatus 1 falsely detected the start of emission of radiation, the radiology technician stops the processing in the radiation image capturing apparatus 1 and immediately returns the processing to the state of performing the short cycle reset processing. Therefore, it is possible to advance to the next capturing operation without waiting for the processing performed in the radiation image capturing apparatus 1 in false detection to finish.

Therefore, it is possible to promptly end the string of processing of radiation image capturing and the usability of the radiation image capturing system 50 and the radiation image capturing apparatus 1 to the radiology technician is enhanced. Moreover, since the patient who is the object does not have to wait a long time until the next capturing, the burden on the patient decreases.

As described above, the present invention is not limited to the radiation image capturing apparatus 1 detecting the start of emission of radiation based on the above described detecting method 1, detecting method 2 or other modified detecting method. For example, it is possible to provide in the radiation image capturing apparatus 1 an electric current detecting section which detects an electric current i which flows through the bias line 9 or the connecting line 10 (see FIG. 7, etc.), a sensor which detects the amount of radiation emitted or the like, and it is possible to apply the present invention to the radiation image capturing apparatus which detects the start of emission of radiation based on the above output value.

The same advantageous effects as the present embodiment can be obtained by including the configuration of the radiation image capturing apparatus itself detecting the start of emission of radiation and when the radiation image capturing apparatus detects the start of emission of radiation, the radiation image capturing apparatus notifying that the start of emission of radiation is detected or the radiation image capturing apparatus transmitting the detecting signal to the notifying apparatus to notify that the start of emission of radiation is detected by the radiation image capturing apparatus.

For example, it is possible to configure the apparatus so that a signal is transmitted from the console 58 to the radiation generating apparatus 55 to not allow further operation of the exposure switch 56 or even if the exposure switch 56 is operated, the radiation is not emitted from the radiation source 52 thereafter at the point when the radiation image capturing apparatus 1 detects the start of emission of radiation and the detecting signal is transmitted from the radiation image capturing apparatus 1 as described in the above embodiment.

In this case, for example, after the radiation generating apparatus 55 receives the signal from the console 58, the exposure switch 56 cannot be operated for a predetermined amount of time or even if the exposure switch 56 is operated, the radiation is not emitted from the radiation source 52 for a predetermined amount of time.

In the above configuration, when the radiology technician emits radiation to the radiation image capturing apparatus 1, and the radiation image capturing apparatus 1 normally detects the start of emission of radiation, even when the exposure switch 56 cannot be operated for a predetermined amount of time thereafter, the radiation image capturing apparatus 1 performs the reading processing of the image data D, etc. and is not in a state to be able to emit radiation. Therefore, there is no particular inconvenience in such configuration.

When the radiation image capturing apparatus 1 falsely detects start of emission of radiation and even if the radiology technician does not notice and attempts to emit the radiation to the radiation image capturing apparatus 1, at least for during the predetermined amount of time, the exposure switch 56 cannot be operated and the radiation is not emitted to the radiation image capturing apparatus 1.

Therefore, it is possible to accurately prevent needless radiation being emitted on the patient who is the object and the amount of radiation on emitted on the patient increasing. The radiology technician is able to notice that the radiation image capturing apparatus 1 falsely detected the start of emission of radiation and can perform suitable processing such as stop processing such as the reading processing of the image data D automatically performed by the radiation image capturing apparatus 1.

The present embodiment assumes a radiation image capturing apparatus 50 shown in FIG. 12 where examples of the radiation image capturing apparatus 1 receiving shock are, the radiation image capturing apparatus 1 being inserted between the bed B and the body of the patient H and the radiation image capturing apparatus 1 being placed directly against the body of the patient.

However, for example, in the radiation image capturing system 50 shown in FIG. 11 where the radiation image capturing apparatus 1 is mounted on the bucky apparatus 51 to detect the start of emission of radiation with the apparatus using the above detecting method 1 and detecting method 2, there is a possibility that the radiation image capturing apparatus 1 receives a relatively strong shock and based on the above, the radiation image capturing apparatus 1 may falsely detect the start of emission of radiation.

Therefore, in this case, by applying the present invention, even if the radiation image capturing apparatus 1 falsely detects start of emission of radiation when the radiation is not emitted, the radiology technician can notice the above and it is possible for the radiology technician to not emit radiation to the radiation image capturing apparatus 1.

Therefore, it is possible to obtain the same advantageous effects as the above embodiment such as being able to accurately prevent radiation from being emitted on the radiation image capturing apparatus 1 which performs the processing based on the false detection.

The present embodiment is not limited to the above and suitable modification is possible without leaving the scope of the present invention.

The present application is based on Japanese Patent Application No. 2011-233481 filed on Oct. 25, 2011 and Japanese Patent Application No. 2011-257223 filed on Nov. 25, 2011 to the Japanese Patent Office, which shall be a basis for correcting mistranslations.

What is claimed is:

1. A radiation image capturing system comprising:
a radiation image capturing apparatus; and
a radiation generating apparatus which controls a radiation source to emit radiation to the radiation image capturing apparatus, wherein
the radiation image capturing apparatus includes:
a plurality of scanning lines and a plurality of signal lines provided so as to intersect each other;
a plurality of radiation detecting elements which are two dimensional arranged by providing each of the radiation detecting elements in each of small regions defined by the plurality of scanning lines and the plurality of signal lines;
a scanning driving section which applies on voltage or off voltage to each scanning line;
a switch section which is connected to each scanning line and which discharges charge accumulated in the radiation detecting element to the signal line when an on voltage is applied;
a reading circuit which converts the charge discharged from the radiation detecting element to image data to read the image data; and
a control section which drives at least the scanning driving section and the reading circuit to perform reading processing of the image data, wherein
the control section of the radiation image capturing apparatus detects a start of emission of radiation from the radiation source; and
the control section of the radiation image capturing apparatus includes a notifying section which notifies that start of emission of radiation is detected when the start of emission of radiation is detected.

2. The radiation image capturing system of claim 1, wherein, before radiation image capturing, the control section of the radiation image capturing apparatus performs reading processing of leak data in which leak data is converted from the charge which leaks from each radiation detecting element through each switch section in a state where off voltage is applied to each scanning line from the scanning driving section to set each switch section to an off state and detects start of emission of radiation at a point in time when the read leak data exceeds a threshold value.

3. The radiation image capturing system of claim 2, wherein, before radiation image capturing, the control section of the radiation image capturing apparatus alternately performs the reading processing of the leak data and the reset processing of each radiation detecting element which discharges the charge remaining in each radiation detecting element to the signal line by sequentially applying on voltage to each scanning line from the scanning driving section.

4. The radiation image capturing system of claim 1, wherein, before radiation image capturing, the control section of the radiation image capturing apparatus performs reading processing of radiation start detecting image data from each radiation detecting element by sequentially applying on voltage to each scanning line from the scanning driving section and detects start of emission of radiation at a point in time when the read image data exceeds a threshold value.

5. The radiation image capturing system of claim 1, further comprising an instruction signal transmitting section which can transmit to the radiation image capturing apparatus an instruction signal instructing start of detecting processing to detect start of emission of radiation,
wherein the radiation image capturing apparatus performs reset processing of each radiation detecting element before receiving the instruction signal, and when the radiation image capturing apparatus receives the instruction signal, the radiation image capturing apparatus advances the processing to the detecting processing.

6. The radiation image capturing system of claim 1, further comprising a cancel signal transmitting section which can transmit to the radiation image capturing apparatus a cancel signal which instructs processing being performed to be stopped,
wherein the radiation image capturing apparatus stops the processing being performed at this point in time to return to a state which performs reset processing of each radiation detecting element when the cancel signal is received.

7. The radiation image capturing system of claim 6, wherein, the radiation image capturing apparatus returns to a state which performs reset processing of each radiation detecting element as well as destroy the data when there is data obtained in the processing performed until then.

8. A radiation image capturing system comprising:
a radiation image capturing apparatus;
a radiation generating apparatus which controls a radiation source to emit radiation to the radiation image capturing apparatus; and
a notifying apparatus including a notifying section,
wherein
the radiation image capturing apparatus includes:
a plurality of scanning lines and a plurality of signal lines provided so as to intersect each other;
a plurality of radiation detecting elements which are two dimensional arranged by providing each of the radiation detecting elements in each of small regions defined by the plurality of scanning lines and the plurality of signal lines;
a scanning driving section which applies on voltage or off voltage to each scanning line;
a switch section which is connected to each scanning line and which discharges charge accumulated in the radiation detecting element to the signal line when an on voltage is applied;
a reading circuit which converts the charge discharged from the radiation detecting element to image data to read the image data;
a control section which drives at least the scanning driving section and the reading circuit to perform reading processing of the image data; and
a communication section which transmits the image data to an external apparatus, wherein
the control section of the radiation image capturing apparatus detects a start of emission of radiation from the radiation source and when the start of emission of radiation is detected, the control section transmits to the notifying apparatus a detecting signal showing that the start of emission of radiation is detected; and
when the detecting signal is received from the radiation image capturing apparatus, the notifying apparatus notifies through the notifying section that the radiation image capturing apparatus detected the start of emission of radiation.

9. The radiation image capturing system of claim 8, wherein, before radiation image capturing, the control section of the radiation image capturing apparatus performs reading processing of leak data in which leak data is converted from the charge which leaks from each radiation detecting element through each switch section in a state where off voltage is applied to each scanning line from the scanning driving section to set each switch section to an off state and detects start of emission of radiation at a point in time when the read leak data exceeds a threshold value.

10. The radiation image capturing system of claim 9, wherein, before radiation image capturing, the control section of the radiation image capturing apparatus alternately performs the reading processing of the leak data and the reset processing of each radiation detecting element which discharges the charge remaining in each radiation detecting element to the signal line by sequentially applying on voltage to each scanning line from the scanning driving section.

11. The radiation image capturing system of claim 8, wherein, before radiation image capturing, the control section of the radiation image capturing apparatus performs reading processing of radiation start detecting image data from each radiation detecting element by sequentially applying on voltage to each scanning line from the scanning driving section and detects start of emission of radiation at a point in time when the read image data exceeds a threshold value.

12. The radiation image capturing system of claim 8, further comprising an instruction signal transmitting section which can transmit to the radiation image capturing apparatus an instruction signal instructing start of detecting processing to detect start of emission of radiation,
wherein the radiation image capturing apparatus performs reset processing of each radiation detecting element before receiving the instruction signal, and when the radiation image capturing apparatus receives the instruction signal, the radiation image capturing apparatus advances the processing to the detecting processing.

13. The radiation image capturing system of claim 8, further comprising a cancel signal transmitting section which can transmit to the radiation image capturing apparatus a cancel signal which instructs processing being performed to be stopped,
wherein the radiation image capturing apparatus stops the processing being performed at this point in time to return to a state which performs reset processing of each radiation detecting element when the cancel signal is received.

14. The radiation image capturing system of claim 13, wherein, the radiation image capturing apparatus returns to a state which performs reset processing of each radiation detecting element as well as destroy the data when there is data obtained in the processing performed until then.

15. A radiation image capturing apparatus comprising:
a plurality of scanning lines and a plurality of signal lines provided so as to intersect each other;
a plurality of radiation detecting elements which are two dimensional arranged by providing each of the radiation detecting elements in each of small regions defined by the plurality of scanning lines and the plurality of signal lines;
a scanning driving section which applies on voltage or off voltage to each scanning line;
a switch section which is connected to each scanning line and which discharges charge accumulated in the radiation detecting element to the signal line when an on voltage is applied;
a reading circuit which converts the charge discharged from the radiation detecting element to image data to read the image data; and
a control section which drives at least the scanning driving section and the reading circuit to perform reading processing of the image data, wherein
the control section detects a start of emission of radiation from a radiation source; and
the control section includes a notifying section which notifies that start of emission of radiation is detected when the start of emission of radiation is detected.
